(19) United States
(12) Patent Application Publication
(10) Pub. No.: US 2022/0400677 A1
(43) Pub. Date: Dec. 22, 2022

(54) PESTICIDAL MIXTURES

(71) Applicant: ADAMA MAKHTESHIM LTD., Beer-Sheva (IL)

(72) Inventors: Gerson DALLA CORTE, Londrina (BR); Joao IBELLI, Londrina (BR); Ernesto BENETTI, Londrina (BR)

(21) Appl. No.: 17/765,651

(22) PCT Filed: Oct. 1, 2020
(86) PCT No.: PCT/IL2020/051070

§ 371 Date: Mar. 31, 2022

Related U.S. Application Data
(60) Provisional application No. 62/909,826, filed on Oct. 3, 2019.

(51) Int. Cl. A01N 43/56; A01N 43/713; A01N 43/54; A01N 43/78; A01P 7/04; A01P 3/00

(52) U.S. Cl. CPC A01N 43/56; A01N 43/713; A01N 43/54; A01N 43/78; A01P 7/04; A01P 3/00

(57) ABSTRACT

The present subject matter provides a pesticidal mixture comprising: (i) an anthranilamide compound of formula (I); (ii) fluensulfone; optionally (iii) a strobilurin fungicide; and further optionally (iv) a neonicotinoid insecticide.

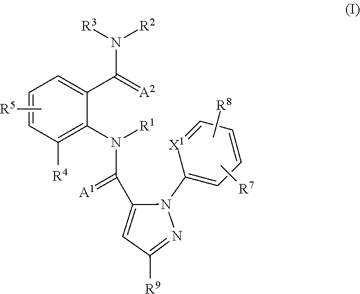

### RELATED APPLICATION/S

This application claims benefit of U.S. Provisional Application No. 62/909,826 filed 3 Oct. 2019, the entire content of which is hereby incorporated by reference herein.

Throughout this application, various publications are cited. Disclosures of the documents and publications referred to herein are hereby incorporated in their entireties by reference into this application.

### FIELD OF THE PRESENT SUBJECT MATTER

The present subject matter relates to a pesticidal mixture that comprises (i) an anthranilamide compound of formula (I); (ii) fluensulfone; optionally (iii) a strobilurin fungicide; and further optionally (iv) a neonicotinoid insecticide.

### BACKGROUND OF THE PRESENT SUBJECT MATTER

Crop protection is critical from early stages of crop development. Preventing pests and diseases at the root of the crop during root development leads to increased crop health and yield. Young roots are most sensitive and there is a need to develop multi-functional mixtures with broad spectrum activity against pests and diseases which affect the crop during the crop's early developmental stages.

Roots are highly affected by nematodes, insects and pathogens at the locus of the plant.

Anthranilamide compounds of formula (I) are a class of insecticides that provides control through action on the ryanodine receptor. These compounds activate this receptor, leading to the unregulated loss of stored calcium. This causes impaired regulation of muscle contraction.

Fluensulfone (5-chloro-2-(3,4,4-trifluorobut-3-en-1-ylsulfonyl)-1,3-thiazole) is a nematocide which has a significantly reduced environmental impact with low toxicity to non-target insects and mammals. Fluensulfone's mode of action is distinct from currently available nematicides and therefore presents a promising new chemical entity for crop protection.

Insecticide and fungicide are also required for improving root development.

Strobilurin fungicides are of QoI inhibitors, which act to inhibit the respiratory chain at the level of Complex III. Strobilurins are generally contact fungicides.

Neonicotinoids are a class of insecticides which act on the central nervous system of insects, blocking an acetylcholine receptor. They are a class of synthetic compounds based on the naturally occurring compound nicotine. Neonicotinoids are among the most widely used insecticides worldwide.

There is a need in the art for pesticidal active ingredients which are effective against a broad spectrum of pests, such as for example, nematodes, insects and fungi.

There is a need in the art to develop a broad-spectrum treatment which is effective for controlling multi-pest attacks on crops in a simple and effective way.

There is a need in the art to find a simple and uniform solution for protecting a crop at the critical stage of its growth, for improving the development of the root system and for promoting better and more efficient of rooting in crop.

It is an object of the present subject matter to provide mixtures which, at a reduced amount of active compounds applied, have improved activity against pests.

### SUMMARY OF THE PRESENT SUBJECT MATTER

The present subject matter provides a pesticidal mixture comprising: (i) an anthranilamide compound of formula (I)

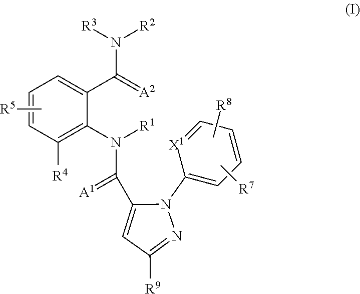

in which

A¹ and A² independently of one another represent oxygen or sulfur,

X¹ represents N or CR¹⁰,

R¹ represents hydrogen or represents C₁-C₆-alkyl, C₂-C₆-alkenyl, C₂-C₆-alkynyl or C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-alkylthio, C₁-C₄-alkylsulfinyl, C₁-C₄-alkylsulfonyl, C₂-C₄-alkoxycarbonyl, C₁-C₄-alkylamino, C₂-C₈-dialkylamino, C₃-C₆-cycloalkylamino, (C₁-C₄-alkyl)-C₃-C₆-cycloalkylamino and R¹¹,

R² represents hydrogen, C₁-C₆-alkyl, C₂-C₆-alkenyl, C₂-C₆-alkynyl, C₃-C₆-cycloalkyl, C₁-C₄-alkoxy, C₁-C₄-alkylamino, C₂-C₈-dialkylamino, C₃-C₆-cycloalkylamino, C₂-C₆-alkoxycarbonyl or C₂-C₆-alkylcarbonyl,

R³ represents hydrogen, R¹¹ or represents C₁-C₆-alkyl, C₂-C₆-alkenyl, C₂-C₆-alkynyl, C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₂-C₆-alkoxycarbonyl, C₂-C₆-alkylcarbonyl, C₃-C₆-trialkylsilyl, R¹¹, phenyl, phenoxy and a 5- or 6-membered heteroaromatic ring, where each phenyl, phenoxy and 5- or 6-membered heteroaromatic ring may optionally be substituted and where the substituents independently of one another may be selected from one to three radicals W or one or more radicals R¹², or

R² and R³ may be attached to one another and form the ring M,

R⁴ represents hydrogen, C₁-C₆-alkyl, C₂-C₆-alkenyl, C₂-C₆-alkynyl, C₃-C₆-cycloalkyl, C₁-C₆-haloalkyl, C₂-C₆-haloalkenyl, C₂-C₆-haloalkynyl, C₃-C₆-halocycloalkyl, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-cycloalkylamino, C₃-C₆-trialkylsilyl or represents phenyl, benzyl or phenoxy, each of which is optionally mono- or polysubstituted, where the substituents independently of one another may be selected from the group consisting of C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfinyl, C₁-C₄-alkylsulfonyl, C₁-C₄-alkylamino, C₂-C₈-dialkylamino, C₃-C₆-cycloalkylamino, C₃-C₆-(alkyl)cycloalkylamino, C₂-C₄-alkylcarbonyl, C₂-C₆-alkoxycarbonyl, C₂-C₆-alkylaminocarbonyl, C₃-C₈-dialkylaminocarbonyl and C₃-C₆-trialkylsilyl,

R⁵ and R⁸ in each case independently of one another represent hydrogen, halogen or represent in each case optionally substituted C₁-C₄-alkyl, C₁-C₄-haloalkyl, R¹², G, J, —OJ, —OG, —S(O)ₚ-J, —S(O)ₚG, —S(O)ₚ-phenyl, where the substituents independently of one another may be selected from one to three radicals W or from the group consisting of R¹², C₁-C₁₀-alkyl, C₂-C₆-alkenyl, C₂-C₆-alkynyl, C₁-C₄-alkoxy and C₁-C₄-alkylthio, where each substituent may be substituted by one or more substituents independently of one another selected from the group consisting of G, J, R⁶, halogen, cyano, nitro, amino, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-trialkylsilyl, phenyl and phenoxy, where each phenyl or phenoxy ring may optionally be substituted and where the substituents independently of one another may be selected from one to three radicals W or one or more radicals R¹²,

G in each case independently of one another represents a 5- or 6-membered non-aromatic carbocyclic or heterocyclic ring which may optionally contain one or two ring members from the group consisting of C(═O), SO and S(═O)₂ and which may optionally be substituted by one to four substituents independently of one another selected from the group consisting of C₁-C₂-alkyl, halogen, cyano, nitro and C₁-C₂-alkoxy, or independently of one another represents C₂-C₆-alkenyl, C₂-C₆-alkynyl, C₃-C₇-cycloalkyl, (cyano)-C₃-C₇-cycloalkyl, (C₁-C₄-alkyl)-C₃-C₆-cycloalkyl, (C₃-C₆-cycloalkyl)-C₁-C₄-alkyl, where each cycloalkyl, (alkyl)cycloalkyl and (cycloalkyl)alkyl may optionally be substituted by one or more halogen atoms,

J in each case independently of one another represents an optionally substituted 5- or 6-membered heteroaromatic ring, where the substituents independently of one another may be selected from one to three radicals W or one or more radicals R¹²,

R⁶ independently of one another represents —C(=E¹)R¹⁹, -L(=E¹)R¹⁹, —C(=E¹)LR¹⁹, -LC(=E¹)LR¹⁹, —OP(=Q)(OR¹⁹)₂, —SO₂LR¹⁸ or -LSO₂LR¹⁹, where each E¹ independently of one another represents O, S, N—R¹⁵, N—OR¹⁵, N—N(R¹⁵)₂, N—S═O, N—CN or N—NO₂,

R⁷ represents hydrogen, C₁-C₄-alkyl, C₁-C₄-haloalkyl, halogen, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl,

R⁹ represents C₁-C₄-haloalkyl, C₁-C₄-haloalkoxy, C₁-C₄-haloalkylsulfinyl or halogen,

R¹⁰ represents hydrogen, C₁-C₄-alkyl, C₁-C₄-haloalkyl, halogen, cyano or C₁-C₄-haloalkoxy,

R¹¹ in each case independently of one another represents in each case optionally mono- to trisubstituted C₁-C₆-alkylthio, C₁-C₆-alkylsulfenyl, C₁-C₆-haloalkylthio, C₁-C₆-haloalkylsulfenyl, phenylthio or phenylsulfenyl, where the substituents independently of one another may be selected from the list W, —S(O)ₙN(R¹⁶)₂, —C(═O)R¹³, -L(C═O)R¹⁴, —S(C═O)LR¹⁴, —C(═O)LR¹³, —S(O)ₙNR¹³C(═O)R¹³, —S(O)ₙNR¹³C(═O)LR¹⁴ or —S(O)ₙNR¹³S(O)₂LR¹⁴,

L in each case independently of one another represents O, NR¹⁸ or S,

R¹² in each case independently of one another represents —B(OR¹⁷)₂, amino, SH, thiocyanato, C₃-C₈-trialkylsilyloxy, C₁-C₄-alkyl disulfides, —SF₅, —C(=E¹)R¹⁹, -LC(=E¹)R¹⁹, —C(=E¹)LR¹⁹, -LC(=E¹)LR¹⁹, —OP(=Q)(OR¹⁹)₂, —SO₂LR¹⁹ or -LSO₂LR¹⁹,

Q represents O or S,

R¹³ in each case independently of one another represents hydrogen or represents in each case optionally mono- or polysubstituted C₁-C₆-alkyl, C₂-C₆-alkenyl, C₂-C₆-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino or (C₁-C₄-alkyl)-C₃-C₆-cycloalkylamino,

R¹⁴ in each case independently of one another represents in each case optionally mono- or polysubstituted C₂-C₂₀-alkenyl, C₂-C₂₀-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino and (C₁-C₄-alkyl)-C₃-C₆-cycloalkylamino or represent optionally substituted phenyl, where the substituents independently of one another may be selected from one to three radicals W or one or more radicals R¹²,

R¹⁵ in each case independently of one another represents hydrogen or represents in each case optionally mono- or polysubstituted C₁-C₆-haloalkyl or C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₂-C₆-alkoxycarbonyl, C₂-C₆-alkylcarbonyl, C₃-C₆-trialkylsilyl and optionally substituted phenyl, where the substituents independently of one another may be selected from one to three radicals W or one or more radicals R¹², or N(R¹⁵)₂ represents a cycle which forms the ring M,

R¹⁶ represents C₁-C₁₂-alkyl or C₁-C₁₂-haloalkyl, or N(R¹⁶)₂ represents a cycle which forms the ring M,

R¹⁷ in each case independently of one another represents hydrogen or C₁-C₄-alkyl, or B(OR¹⁷)₂ represents a ring in which the two oxygen atoms are attached via a chain having two to three carbon atoms which are optionally substituted by one or two substituents independently of one another selected from the group consisting of methyl and C₂-C₆-alkoxycarbonyl,

R¹⁸ in each case independently of one another represents hydrogen, C₁-C₆-alkyl or C₁-C₆-haloalkyl, or N(R¹³)(R¹⁸) represents a cycle which forms the ring M,

R¹⁹ in each case independently of one another represents hydrogen or represents in each case mono- or polysubstituted C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, CO₂H, C₂-C₆-alkoxycarbonyl, C₂-C₆-alkylcarbonyl, C₃-C₆-trialkylsilyl and optionally substituted phenyl, where the substituents independently of one another may be selected from one to three radicals W, C₁-C₆-haloalkyl, C₃-C₆-cycloalkyl or phenyl or pyridyl, each of which is optionally mono- to trisubstituted by W,

M in each case represents an optionally mono- to tetrasubstituted ring which, in addition to the nitrogen atom attached to the substituent pair R¹³ and R¹⁸, (R¹⁵)₂ or (R¹⁶)₂, contains two to six carbon atoms and optionally additionally a further nitrogen, sulfur or oxygen atom, where the substituents independently of one another may be selected from the group consisting of C₁-C₂-alkyl, halogen, cyano, nitro and C₁-C₂-alkoxy,

W in each case independently of one another represents C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfonyl, C₁-C₄-alkylamino, C₂-C₈-dialkylamino, C₃-C₆-cycloalkylamino, (C₁-C₄-alkyl)-C₃-C₆-cycloalkylamino, C₂-C₄-alkylcarbonyl, C₂-C₆-alkoxycarbonyl, CO₂H, C₂-C₆-alkylaminocarbonyl, C₃-C₈-dialkylaminocarbonyl or C₃-C₆-trialkylsilyl,

n in each case independently of one another represents 0 or 1,

p in each case independently of one another represents 0, 1 or 2,

where, if (a) R⁵ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio or halogen and (b) R⁸ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio, halogen, C₂-C₄-alkylcarbonyl, C₂-C₆-alkoxycarbonyl, C₂-C₆-alkylaminocarbonyl or C₃-C₈ dialkylaminocarbonyl, (c) at least one substituent selected from the group consisting of R⁶, R¹¹ and R¹² if present and (d) if R¹² is not present, at least one of the radicals R⁶ and R¹¹ is different from C₂-C₆-alkylcarbonyl, C₂-C₆-alkoxycarbonyl, C₂-C₆-alkylaminocarbonyl and C₃-C₈-dialkylaminocarbonyl, and where the compound of the general formula (I) may also be an N-oxide or salt;

(ii) fluensulfone; optionally (iii) a strobilurin fungicide; and further optionally (iv) a neonicotinoid insecticide.

The present subject matter also provides a pesticidal mixture comprising: (i) an anthranilamide compound of formula (I); (ii) fluensulfone; (iii) a strobilurin fungicide; and optionally (iv) a neonicotinoid insecticide.

The present subject matter further provides a pesticidal mixture comprising: (i) an anthranilamide compound of formula (I); (ii) fluensulfone; (iii) a neonicotinoid insecticide; and optionally (iv) a strobilurin fungicide.

The present subject matter further provides a pesticidal mixture comprising: (i) an anthranilamide compound of formula (I); (ii) fluensulfone; (iii) a strobilurin fungicide; and (iv) a neonicotinoid insecticide.

The present subject matter also provides a pesticidal mixture comprising: (i) an amount of anthranilamide compound of formula (I); (ii) an amount of fluensulfone; optionally (iii) an amount of strobilurin fungicide; and optionally (iv) an amount of neonicotinoid insecticide wherein the amount of compound of formula (I), the amount of fluensulfone; the amount of a strobilurin fungicide and/or the amount of a neonicotinoid insecticide if applied together are more effective than when (i) at the same amount, (ii) at the same amount, (iii) at the same amount and/or (iv) at the same amount is applied alone.

The present subject matter also provides a pesticidal mixture comprising: (i) an amount of anthranilamide compound of formula (I); (ii) an amount of fluensulfone; (iii) an amount of strobilurin fungicide; and (iv) an amount of neonicotinoid insecticide wherein the amount of anthranilamide compound of formula (I); an amount of fluensulfone; an amount of strobilurin fungicide; and/or an amount of neonicotinoid insecticide applied is less than the pesticidal effective amount of (i), (ii), (iii) and/or (iv) when (i), (ii), (iii) and/or (iv) is used alone

The present subject matter provides a composition comprising any mixture or combination described herein.

### DETAILED DESCRIPTION OF THE PRESENT SUBJECT MATTER

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

As used herein, the term “pests” is used to include animal pests, as well as harmful fungi.

As used herein, the term “broad spectrum” is used to describe efficiency against a wide range of diseases and infections of the plant, the locus thereof or propagation material thereof.

As used herein, the terms “control” or “controlling” are meant to include, but are not limited to, any killing, growth regulating, inhibiting or interfering with the normal life cycle of the pest activities of a given pest. These terms include for example preventing larvae from developing into mature insects, modulating the emergence of pests from eggs including preventing eclosion, degrading the egg material, suffocation, reducing gut motility, inhibiting the formation of chitin, disrupting mating or sexual communication, and preventing feeding activity. The terms “control” and “controlling” also include the ability to modulate or inhibit the growth or proliferation or colony formation of an organism or an organism population.

As used herein, the term “effective” when used to describe a method for controlling of undesired pest, such as nematodes, means that the method provides a good level of control of the undesired pest without significantly interfering with the normal growth and development of the crop.

As used herein, the term “effective amount” when used in connection with an active component refers to an amount of the active component that, when ingested, contacted with or sensed, is sufficient to achieve a good level of control or activity.

As used herein, the term “effective amount” when used in connection with a non-active component, i.e. additive, such as polymer and organic carrier, refers to an amount of the additive that is sufficient to improve the stability of the composition.

As used herein, the term “agriculturally acceptable carrier” means carrier which are known and accepted in the art for the formation of compositions for agricultural or horticultural use.

As used herein, the term “adjuvant” is broadly defined as any substance that itself is not an active ingredient but which enhances or is intended to enhance the effectiveness of the pesticide with which it is used. Adjuvants may be understood to include, but are not limited to, spreading agents, penetrants, compatibility agents, and drift retardants.

As used herein, the term “agriculturally acceptable inert additives” is defined as any substance that itself is not an active ingredient but is added to the composition such as thickening agent, sticking agents, surfactants, anti-oxidation agent, anti-foaming agents and thickeners.

As used herein, the term “tank mix” means that two or more chemical pesticides or compositions are mixed in the spray tank at the time of spray application.

As used herein, the term “ready mix” means a composition that may be applied to plants directly after dilution. The composition comprises the combination of the active ingredients.

As used herein the term “plant” includes reference to the whole plant, plant organ (e.g., leaves, stems, twigs, roots, trunks, limbs, shoots, fruits etc.), and propagation material or plant cells.

As used herein the term “plant” includes reference to agricultural crops including field crops (soybean, maize, wheat, rice, etc.), vegetable crops (potatoes, cabbages, etc.), fruits (peach, etc.), semi-perennial crops (sugarcane) and perennial crops (coffee and guava).

As used herein the term “propagation material” is to be understood to denote all the generative parts of the plant such as seeds and spores, vegetative structures such as bulbs, corms, tubers, rhizomes, roots stems, basal shoots, stolons and buds.

As used herein, the term “locus” includes a habitat, breeding ground, plant, propagation material, soil, area, material or environment in which a pest is growing or may grow.

As used herein the term “ha” refers to hectare.

As used herein, the term “mixture” or “combination” refers, but is not limited to, a combination in any physical form, e.g., blend, solution, suspension, dispersion, emulsion, alloy, or the like.

As used herein, the term “more effective” includes, but is not limited to, increasing efficacy of pesticidal disease control, prolonging protection and reducing the amount of time needed to achieve a given level of pesticidal control, prolonging the duration of protection against pest attack after application and extending the protection period against pest attack and/or reducing the amount of time needed to achieve a level of pest control compared to when each pesticide at the same amount is applied alone.

Pest refer to pathogen, insect, nematodes and any combination thereof.

As used herein, the term “cultivated plants” includes plants which have been modified by breeding, mutagenesis or genetic engineering. Genetically modified plants are plants, which genetic material has been modified by the use of recombinant DNA techniques. Typically, one or more genes have been integrated into the genetic material of such a plant in order to improve certain properties of the plant.

The term “enhancing crop plants” as used herein means improving one or more of plant quality, plant vigor, nutrient uptake, root system, tolerance to stress factors, and/or yield in a plant to which the mixture or composition described herein has been applied as compared to a control plant grown under the same conditions except to which the mixture or composition described herein has not been applied.

The term “enhancing roots system” as used herein means the roots system is improved qualitatively or quantitatively in plant to which the mixture or composition described herein has been applied as compared to the roots systems in a control plant grown under the same conditions except to which the mixture or composition described herein has not been applied. Enhanced roots systems include but are not limited to improved visual appearance and composition of the roots system (i.e., improved color, density, and uniformity), increased root growth, a more developed root system, stronger and healthier roots, improved plant stand, and increased roots system weight.

The term “improving plant quality” as used herein means that one or more traits are improved qualitatively or quantitatively in a plant to which the mixture or composition described herein has been applied as compared to the same trait in a control plant grown under the same conditions except to which the mixture or composition described herein has not been applied. Such traits include but are not limited to improved visual appearance and composition of the plant (i.e., improved color, density, uniformity, compactness), reduced ethylene (reduced production and/or inhibition of reception), improved visual appearance and composition of harvested material (i.e., seeds, fruits, leaves, vegetables, shoot/stem/cane),), improved carbohydrate content (i.e., increased quantities of sugar and/or starch, improved sugar acid ratio, reduction of reducing sugars, increased rate of development of sugar), improved protein content, improved oil content and composition, improved nutritional value, reduction in anti-nutritional compounds, increased nutrient uptake, stronger and healthier roots, improved organoleptic properties (i.e., improved taste), improved consumer health benefits (i.e., increased levels of vitamins and antioxidants), improved post-harvest characteristics (i.e., enhanced shelf-life and/or storage stability, easier processability, easier extraction of compounds), and/or improved seed quality (i.e., for use in following seasons).

As used herein, the term “plant growth regulation” or “regulating plant growth” includes restricting vertical stem growth, promoting root growth, stunting, increasing stem diameter and stem-wall thickness, and the like.

As used herein, the term “mixture” or “combination” refers, but is not limited to, a combination in any physical form, e.g., blend, solution, alloy, or the like.

As used herein, the term “plants” refers to any and all physical parts of a plant, including but not limited to seeds, seedlings, saplings, roots, tubers, stems, stalks, foliage, and fruits.

As used herein, the term “surfactant” means an agriculturally acceptable material which imparts emulsifiability, stability, spreading, wetting, dispersibility or other surface-modifying properties. Examples of suitable surfactants include non-ionic, anionic, cationic and ampholytic surfactants.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of”.

For purposes of better understanding the present teachings and in no way limiting the scope of the teachings, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

It is further understood that where a parameter range is provided, all integers within that range, and tenths thereof, are also provided by the subject matter. For example, “0.1% to 50%” includes 0.1%, 0.2%, 0.3%, 0.4% etc. up to 50%.

### Pesticidal Mixtures

Anthranilamide insecticides, fluensulfone, strobilurin fungicides and neonicotinoid insecticide have all been studied and used for many years. For many crops, there is a need for a combination of different pesticides in order to control multiple pests simultaneously, enhancing plant development for improving root development and efficiency of rooting.

The present subject matter relates to a pesticidal mixture comprising: (i) an anthranilamide compound of formula (I);

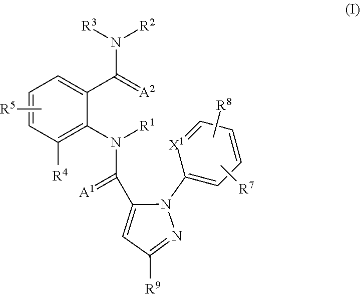

in which

A¹ and A² independently of one another represent oxygen or sulfur,

X¹ represents N or CR¹⁰,

R¹ represents hydrogen or represents C₁-C₆-alkyl, C₂-C₆-alkenyl, C₂-C₆-alkynyl or C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-alkylthio, C₁-C₄-alkylsulfinyl, C₁-C₄-alkylsulfonyl, C₂-C₄-alkoxycarbonyl, C₁-C₄-alkylamino, C₂-C₈-dialkylamino, C₃-C₆-cycloalkylamino, (C₁-C₄-alkyl)-C₃-C₆-cycloalkylamino and R¹¹,

R² represents hydrogen, C₁-C₆-alkyl, C₂-C₆-alkenyl, C₂-C₆-alkynyl, C₃-C₆-cycloalkyl, C₁-C₄-alkoxy, C₁-C₄-alkylamino, C₂-C₈-dialkylamino, C₃-C₆-cycloalkylamino, C₂-C₆-alkoxycarbonyl or C₂-C₆-alkylcarbonyl,

R³ represents hydrogen, R¹¹ or represents C₁-C₆-alkyl, C₂-C₆-alkenyl, C₂-C₆-alkynyl, C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₂-C₆-alkoxycarbonyl, C₂-C₆-alkylcarbonyl, C₃-C₆-trialkylsilyl, R¹¹, phenyl, phenoxy and a 5- or 6-membered heteroaromatic ring, where each phenyl, phenoxy and 5- or 6-membered heteroaromatic ring may optionally be substituted and where the substituents independently of one another may be selected from one to three radicals W or one or more radicals R¹², or

R² and R³ may be attached to one another and form the ring M,

R⁴ represents hydrogen, C₁-C₆-alkyl, C₂-C₆-alkenyl, C₂-C₆-alkynyl, C₃-C₆-cycloalkyl, C₁-C₆-haloalkyl, C₂-C₆-haloalkenyl, C₂-C₆-haloalkynyl, C₃-C₆-halocycloalkyl, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-cycloalkylamino, C₃-C₆-trialkylsilyl or represents phenyl, benzyl or phenoxy, each of which is optionally mono- or polysubstituted, where the substituents independently of one another may be selected from the group consisting of C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfinyl, C₁-C₄-alkylsulfonyl, C₁-C₄-alkylamino, C₂-C₈-dialkylamino, C₃-C₆-cycloalkylamino, C₃-C₆-(alkyl)cycloalkylamino, C₂-C₄-alkylcarbonyl, C₂-C₆-alkoxycarbonyl, C₂-C₆-alkylaminocarbonyl, C₃-C₈-dialkylaminocarbonyl and C₃-C₆-trialkylsilyl,

R⁵ and R⁸ in each case independently of one another represent hydrogen, halogen or represent in each case optionally substituted C₁-C₄-alkyl, C₁-C₄-haloalkyl, R¹², G, J, —OJ, —OG, —S(O)ₚ-J, —S(O)ₚG, —S(O)ₚ-phenyl, where the substituents independently of one another may be selected from one to three radicals W or from the group consisting of R¹², C₁-C₁₀-alkyl, C₂-C₆-alkenyl, C₂-C₆-alkynyl, C₁-C₄-alkoxy and C₁-C₄-alkylthio, where each substituent may be substituted by one or more substituents independently of one another selected from the group consisting of G, J, R⁶, halogen, cyano, nitro, amino, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-trialkylsilyl, phenyl and phenoxy, where each phenyl or phenoxy ring may optionally be substituted and where the substituents independently of one another may be selected from one to three radicals W or one or more radicals R¹²,

G in each case independently of one another represents a 5- or 6-membered non-aromatic carbocyclic or heterocyclic ring which may optionally contain one or two ring members from the group consisting of C(═O), SO and S(═O)₂ and which may optionally be substituted by one to four substituents independently of one another selected from the group consisting of C₁-C₂-alkyl, halogen, cyano, nitro and C₁-C₂-alkoxy, or independently of one another represents C₂-C₆-alkenyl, C₂-C₆-alkynyl, C₃-C₇-cycloalkyl, (cyano)-C₃-C₇-cycloalkyl, (C₁-C₄-alkyl)-C₃-C₆-cycloalkyl, (C₃-C₆-cycloalkyl)-C₁-C₄-alkyl, where each cycloalkyl, (alkyl)cycloalkyl and (cycloalkyl)alkyl may optionally be substituted by one or more halogen atoms,

J in each case independently of one another represents an optionally substituted 5- or 6-membered heteroaromatic ring, where the substituents independently of one another may be selected from one to three radicals W or one or more radicals R¹²,

R⁶ independently of one another represents —C(=E¹)R¹⁹, -L(=E¹)R¹⁹, —C(=E¹)LR¹⁹, -LC(=E¹)LR¹⁹, —OP(=Q)(OR¹⁹)₂, —SO₂LR¹⁸ or -LSO₂LR¹⁹, where each E¹ independently of one another represents O, S, N—R¹⁵, N—OR¹⁵, N—N(R¹⁵)₂, N—S═O, N—CN or N—NO₂,

R⁷ represents hydrogen, C₁-C₄-alkyl, C₁-C₄-haloalkyl, halogen, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl,

R⁹ represents C₁-C₄-haloalkyl, C₁-C₄-haloalkoxy, C₁-C₄-haloalkylsulfinyl or halogen,

R¹⁰ represents hydrogen, C₁-C₄-alkyl, C₁-C₄-haloalkyl, halogen, cyano or C₁-C₄-haloalkoxy,

R¹¹ in each case independently of one another represents in each case optionally mono- to trisubstituted C₁-C₆-alkylthio, C₁-C₆-alkylsulfenyl, C₁-C₆-haloalkylthio, C₁-C₆-haloalkylsulfenyl, phenylthio or phenylsulfenyl, where the substituents independently of one another may be selected from the list W, —S(O)ₙN(R¹⁶)₂, —C(═O)R¹³, -L(C═O)R¹⁴, —S(C═O)LR¹⁴, —C(═O)LR¹³, —S(O)ₙNR¹³C(═O)R¹³, —S(O)ₙNR¹³C(═O)LR¹⁴ or —S(O)ₙNR¹³S(O)₂LR¹⁴,

L in each case independently of one another represents O, NR¹⁸ or S,

R¹² in each case independently of one another represents —B(OR¹⁷)₂, amino, SH, thiocyanato, C₃-C₈-trialkylsilyloxy, C₁-C₄-alkyl disulfides, —SF₅, —C(=E¹)R¹⁹, -LC(=E¹)R¹⁹, —C(=E¹)LR¹⁹, -LC(=E¹)LR¹⁹, —OP(=Q)(OR¹⁹)₂, —SO₂LR¹⁹ or -LSO₂LR¹⁹,

Q represents O or S,

R¹³ in each case independently of one another represents hydrogen or represents in each case optionally mono- or polysubstituted C₁-C₆-alkyl, C₂-C₆-alkenyl, C₂-C₆-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino or (C₁-C₄-alkyl)-C₃-C₆-cycloalkylamino,

R¹⁴ in each case independently of one another represents in each case optionally mono- or polysubstituted C₂-C₂₀-alkenyl, C₂-C₂₀-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino and (C₁-C₄-alkyl)-C₃-C₆-cycloalkylamino or represent optionally substituted phenyl, where the substituents independently of one another may be selected from one to three radicals W or one or more radicals R¹²,

R¹⁵ in each case independently of one another represents hydrogen or represents in each case optionally mono- or polysubstituted C₁-C₆-haloalkyl or C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₂-C₆-alkoxycarbonyl, C₂-C₆-alkylcarbonyl, C₃-C₆-trialkylsilyl and optionally substituted phenyl, where the substituents independently of one another may be selected from one to three radicals W or one or more radicals R¹², or N(R¹⁵)₂ represents a cycle which forms the ring M,

R¹⁶ represents C₁-C₁₂-alkyl or C₁-C₁₂-haloalkyl, or N(R¹⁶)₂ represents a cycle which forms the ring M,

R¹⁷ in each case independently of one another represents hydrogen or C₁-C₄-alkyl, or B(OR¹⁷)₂ represents a ring in which the two oxygen atoms are attached via a chain having two to three carbon atoms which are optionally substituted by one or two substituents independently of one another selected from the group consisting of methyl and C₂-C₆-alkoxycarbonyl,

R¹⁸ in each case independently of one another represents hydrogen, C₁-C₆-alkyl or C₁-C₆-haloalkyl, or N(R¹³)(R¹⁸) represents a cycle which forms the ring M,

R¹⁹ in each case independently of one another represents hydrogen or represents in each case mono- or polysubstituted C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, CO₂H, C₂-C₆-alkoxycarbonyl, C₂-C₆-alkylcarbonyl, C₃-C₆-trialkylsilyl and optionally substituted phenyl, where the substituents independently of one another may be selected from one to three radicals W, C₁-C₆-haloalkyl, C₃-C₆-cycloalkyl or phenyl or pyridyl, each of which is optionally mono- to trisubstituted by W,

M in each case represents an optionally mono- to tetrasubstituted ring which, in addition to the nitrogen atom attached to the substituent pair R¹³ and R¹⁸, (R¹⁵)₂ or (R¹⁶)₂, contains two to six carbon atoms and optionally additionally a further nitrogen, sulfur or oxygen atom, where the substituents independently of one another may be selected from the group consisting of C₁-C₂-alkyl, halogen, cyano, nitro and C₁-C₂-alkoxy,

W in each case independently of one another represents C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfonyl, C₁-C₄-alkylamino, C₂-C₈-dialkylamino, C₃-C₆-cycloalkylamino, (C₁-C₄-alkyl)-C₃-C₆-cycloalkylamino, C₂-C₄-alkylcarbonyl, C₂-C₆-alkoxycarbonyl, CO₂H, C₂-C₆-alkylaminocarbonyl, C₃-C₈-dialkylaminocarbonyl or C₃-C₆-trialkylsilyl,

n in each case independently of one another represents 0 or 1,

p in each case independently of one another represents 0, 1 or 2,

where, if (a) R⁵ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio or halogen and (b) R⁸ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio, halogen, C₂-C₄-alkylcarbonyl, C₂-C₆-alkoxycarbonyl, C₂-C₆-alkylaminocarbonyl or C₃-C₈ dialkylaminocarbonyl, (c) at least one substituent selected from the group consisting of R⁶, R¹¹ and R¹² if present and (d) if R¹² is not present, at least one of the radicals R⁶ and R¹¹ is different from C₂-C₆-alkylcarbonyl, C₂-C₆-alkoxycarbonyl, C₂-C₆-alkylaminocarbonyl and C₃-C₈-dialkylaminocarbonyl, and where the compound of the general formula (I) may also be an N-oxide or salt;

(ii) fluensulfone; optionally (iii) a strobilurin fungicide; and further optionally (iv) a neonicotinoid insecticide.

The present subject matter relates to a pesticidal mixture comprising: (i) an anthranilamide compound of formula (I); (ii) fluensulfone; (iii) a strobilurin fungicide; and optionally (iv) a neonicotinoid insecticide.

The present subject matter relates to a pesticidal mixture comprising: (i) an anthranilamide compound of formula (I); (ii) fluensulfone; (iii) a neonicotinoid insecticide; and further optionally (iv) a strobilurin fungicide.

The present subject matter relates to a pesticidal mixture comprising: (i) an anthranilamide compound of formula (I); (ii) fluensulfone; (iii) a neonicotinoid insecticide; and optionally (iv) a strobilurin fungicide.

The present subject matter relates to a pesticidal mixture comprising: (i) an anthranilamide compound of formula (I); (ii) fluensulfone; (iii) a strobilurin fungicide; and (iv) a neonicotinoid insecticide.

In an embodiment, the anthranilamide compound of formula (I) is chlorantraniliprole, cyantraniliprole, tetraniliprole, tetrachlorantraniliprole, bromantraniliprole, and cyclaniliprole.

In a specific embodiment, the anthranilamide compound of formula (I) is chlorantraniliprole.

In an embodiment, the strobilurin fungicide is selected from the group consisting of azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin and fluoxastrobin.

In a specific embodiment, the strobilurin fungicide is azoxystrobin.

In an embodiment, the neonicotinoid insecticide is selected from the group consisting of acetamiprid, clothianidin, dinotefuran, imidacloprid, nitenpyram, thiacloprid and thiamethoxam.

In a specific embodiment, the neonicotinoid insecticide is thiamethoxam.

In some embodiments, the pesticidal mixture comprises a combination of a) an anthranilamide compound of formula (I) and b) fluensulfone. In an embodiment, the pesticidal mixture comprises a combination of a) chlorantraniliprole and b) fluensulfone.

In some embodiments, the pesticidal mixture comprises a) an anthranilamide compound of formula (I) and b) fluensulfone. In an embodiment, the pesticidal mixture comprises a) chlorantraniliprole and b) fluensulfone.

In some embodiments, the pesticidal mixture comprises a combination of a) an anthranilamide compound of formula (I), b) fluensulfone and c) a strobilurin fungicide. In an embodiment, the pesticidal mixture comprises a combination of a) chlorantraniliprole, b) fluensulfone, and c) a strobilurin fungicide. In a further embodiment, the pesticidal mixture comprises a combination of a) an anthranilamide compound of formula (I), b) fluensulfone, and c) azoxystrobin. In a specific example, the pesticidal mixture comprises a combination of a) chlorantraniliprole, b) fluensulfone, and c) azoxystrobin.

In some embodiments, the pesticidal mixture comprises a combination of a) an anthranilamide compound of formula (I), b) fluensulfone and c) a neonicotinoid insecticide. In an embodiment, the pesticidal mixture comprises a combination of a) chlorantraniliprole, b) fluensulfone, and c) a neonicotinoid insecticide. In a further embodiment, the pesticidal mixture comprises a combination of a) an anthranilamide compound of formula (I), b) fluensulfone, and c) thiamethoxam. In a specific example, the pesticidal mixture comprises a combination of a) chlorantraniliprole, b) fluensulfone, and c) thiamethoxam.

In some embodiments, the pesticidal mixture comprises a combination of a) an anthranilamide compound of formula (I), b) fluensulfone, c) a strobilurin fungicide and d) a neonicotinoid insecticide. In an embodiment, the pesticidal mixture comprises a combination of a) chlorantraniliprole, b) fluensulfone, c) a strobilurin fungicide and d) a neonicotinoid insecticide.

In a further embodiment, the pesticidal mixture comprises a combination of a) an anthranilamide compound of formula (I), b) fluensulfone, c) azoxystrobin and d) a neonicotinoid insecticide. In a further embodiment, the pesticidal mixture comprises a combination of a) chlorantraniliprole, b) fluensulfone, c) azoxystrobin and d) a neonicotinoid insecticide. In a further embodiment, the pesticidal mixture comprises a combination of a) an anthranilamide compound of formula (I), b) fluensulfone, c) a strobilurin fungicide and d) thiamethoxam. In a further embodiment, the pesticidal mixture comprises a combination of a) chlorantraniliprole, b) fluensulfone, c) a strobilurin fungicide and d) thiamethoxam. In a specific example, the pesticidal mixture comprises a combination of a) chlorantraniliprole, b) fluensulfone, c) azoxystrobin and d) thiamethoxam.

In a further embodiment, the pesticidal mixture comprises a) chlorantraniliprole, b) fluensulfone, c) a strobilurin fungicide and d) thiamethoxam. In a specific example, the pesticidal mixture comprises of a) chlorantraniliprole, b) fluensulfone, c) azoxystrobin and d) thiamethoxam.

The present subject matter also provides a pesticidal mixture comprising: (i) an amount of anthranilamide compound of formula (I); (ii) an amount of fluensulfone; optionally (iii) an amount of strobilurin fungicide; and optionally (iv) an amount of neonicotinoid insecticide.

The present subject matter also provides a pesticidal mixture comprising: (i) an amount of anthranilamide compound of formula (I); (ii) an amount of fluensulfone; (iii) an amount of strobilurin fungicide; and (iv) an amount of neonicotinoid insecticide.

The present subject matter also provides a pesticidal mixture comprising: (i) an amount of anthranilamide compound of formula (I); (ii) an amount of fluensulfone; and (iii) an amount of strobilurin fungicide.

The present subject matter also provides a pesticidal mixture comprising: (i) an amount of anthranilamide compound of formula (I); (ii) an amount of fluensulfone; and (iv) an amount of neonicotinoid insecticide.

In some embodiments, the amount of compound of formula (I), the amount of fluensulfone; the amount of a strobilurin fungicide and the amount of a neonicotinoid insecticide if applied together are more effective than when compound of formula (I), at the same amount, fluensulfone at the same amount, strobilurin fungicide at the same amount and neonicotinoid insecticide at the same amount is applied alone.

In some embodiments, the amount of compound of formula (I) and the amount of fluensulfone; if applied together are more effective than when compound of formula (I), at the same amount and fluensulfone at the same amount is applied alone.

In some embodiments, the amount of compound of formula (I), the amount of fluensulfone; and the amount of a strobilurin fungicide if applied together are more effective than when compound of formula (I) at the same amount, fluensulfone at the same amount and strobilurin fungicide at the same amount is applied alone.

In some embodiments, the amount of compound of formula (I), the amount of fluensulfone; and the amount of a neonicotinoid insecticide if applied together are more effective than when compound of formula (I) at the same amount, fluensulfone at the same amount, and neonicotinoid insecticide at the same amount is applied alone.

In some embodiments, the amount of compound of formula (I), applied is less than the insecticidal effective amount of compound of formula (I), if the compound of formula (I), is used alone.

In some embodiments, the amount of the fluensulfone applied is less than the nematocidal effective amount of the fluensulfone if the fluensulfone is used alone.

In some embodiments, the amount of neonicotinoid insecticide applied is less than the insecticidal effective amount of neonicotinoid insecticide, if the neonicotinoid insecticide, is used alone.

In some embodiments, the amount of strobilurin fungicide applied is less than the fungicidal effective amount of strobilurin fungicide, if the strobilurin fungicide, is used alone.

In some embodiments the mixture is more effective than if compound of formula (I) at the same amount, fluensulfone at the same amount; strobilurin fungicide at the same amount and neonicotinoid insecticide at the same amount are applied alone.

In some embodiments the mixture is more effective than when compound of formula (I) at the same amount and fluensulfone at the same amount are applied alone.

In some embodiments the mixture is more effective than when compound of formula (I) at the same amount, fluensulfone at the same amount and neonicotinoid insecticide at the same amount are applied alone.

In some embodiments the mixture is more effective than when compound of formula (I) at the same amount, fluensulfone at the same amount and strobilurin fungicide at the same amount are applied alone.

The present subject matter also provides a pesticidal mixture comprising: (i) an amount of anthranilamide compound of formula (I); (ii) an amount of fluensulfone; (iii) an amount of strobilurin fungicide; and (iv) an amount of neonicotinoid insecticide, wherein the mixture is more effective than (i), (ii), (iii) and/or (iv) at the same amount is applied alone.

The present subject matter also provides a pesticidal mixture comprising: (i) an amount of anthranilamide compound of formula (I); (ii) an amount of fluensulfone; (iii) an amount of strobilurin fungicide; and (iv) an amount of neonicotinoid insecticide, wherein the mixture is more effective than when at least one of (i), (ii), (iii) and/or (iv) at the same amount is applied alone.

The present subject matter also provides a pesticidal mixture comprising: (i) an amount of anthranilamide compound of formula (I); (ii) an amount of fluensulfone; optionally (iii) an amount of strobilurin fungicide; and optionally (iv) an amount of neonicotinoid insecticide wherein the amount of compound of formula (I), the amount of fluensulfone; the amount of a strobilurin fungicide and/or the amount of a neonicotinoid insecticide if applied together are more effective than when (i) at the same amount, (ii) at the same amount, (iii) at the same amount and/or (iv) at the same amount is applied alone.

The present subject matter also provides a pesticidal mixture comprising: (i) an amount of anthranilamide compound of formula (I); (ii) an amount of fluensulfone; (iii) an amount of strobilurin fungicide; and (iv) an amount of neonicotinoid insecticide wherein the amount of anthranilamide compound of formula (I); an amount of fluensulfone; an amount of strobilurin fungicide; and/or an amount of neonicotinoid insecticide applied is less than the pesticidal effective amount of (i), (ii), (iii) and/or (iv) when (i), (ii), (iii) and/or (iv) is used alone.

In an embodiment, the anthranilamide compound of formula (I) is chlorantraniliprole, cyantraniliprole, tetraniliprole, tetrachlorantraniliprole, bromantraniliprole, and cyclaniliprole.

In a specific embodiment, the anthranilamide compound of formula (I) is chlorantraniliprole.

In an embodiment, the strobilurin fungicide is selected from the group consisting of azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin and fluoxastrobin.

In a specific embodiment, the strobilurin fungicide is azoxystrobin.

In an embodiment, the neonicotinoid insecticide is selected from the group consisting of acetamiprid, clothianidin, dinotefuran, imidacloprid, nitenpyram, thiacloprid and thiamethoxam.

In a specific embodiment, the neonicotinoid insecticide is thiamethoxam.

In some embodiments, the anthranilamide compound of formula (I) is chlorantraniliprole.

In some embodiments, the strobilurin fungicide is azoxystrobin.

In some embodiments, the neonicotinoid insecticide is thiamethoxam.

In some embodiments, the anthranilamide compound of formula (I) is chlorantraniliprole.

In some embodiments, mixture exhibits synergistic effects.

In some embodiments, the mixture is a synergistic mixture.

The present subject matter relates to a synergistic pesticidal mixture comprising: (i) an anthranilamide compound of formula (I); (ii) fluensulfone; (iii) a strobilurin fungicide; and (iv) a neonicotinoid insecticide.

The present subject matter relates to a synergistic pesticidal mixture comprising: (i) chlorantraniliprole; (ii) fluensulfone; (iii) azoxystrobin and (iv) thiamethoxam.

The present subject matter relates to a synergistic pesticidal mixture comprising: (i) chlorantraniliprole; (ii) fluensulfone; and (iii) a azoxystrobin.

The present subject matter relates to a synergistic pesticidal mixture comprising: (i) chlorantraniliprole (ii) fluensulfone; and (iv) thiamethoxam.

The present subject matter relates to a synergistic pesticidal mixture comprising: (i) chlorantraniliprole; (ii) fluensulfone.

In some embodiments, the amount of anthranilamide compound of formula (I) and (ii) an amount of fluensulfone; optionally (iii) an amount of strobilurin fungicide; and optionally (iv) an amount of neonicotinoid insecticide if applied together are more effective in treating a plant or soil against fungal infection than if (i) at the same amount, (ii) at the same amount, (iii) at the same amount and/or (iv) at the same amount is applied alone.

In some embodiments, the amount of anthranilamide compound of formula (I); (ii) an amount of fluensulfone; (iii) an amount of strobilurin fungicide; and (iv) an amount of neonicotinoid insecticide if applied together are more effective in treating a plant or soil against fungal infection than if (i) at the same amount, (ii) at the same amount, (iii) at the same amount and/or (iv) at the same amount is applied alone.

In some embodiments, the amount of anthranilamide compound of formula (I) and (ii) an amount of fluensulfone; optionally (iii) an amount of strobilurin fungicide; and optionally (iv) an amount of neonicotinoid insecticide if applied together are more effective in treating a plant or soil against insect infection than if (i) at the same amount, (ii) at the same amount, (iii) at the same amount and/or (iv) at the same amount is applied alone.

In some embodiments, the amount of anthranilamide compound of formula (I); (ii) an amount of fluensulfone; (iii) an amount of strobilurin fungicide; and (iv) an amount of neonicotinoid insecticide if applied together are more effective in treating a plant or soil against insect infection than if (i) at the same amount, (ii) at the same amount, (iii) at the same amount and/or (iv) at the same amount is applied alone.

In some embodiments, the amount of anthranilamide compound of formula (I) and (ii) an amount of fluensulfone; optionally (iii) an amount of strobilurin fungicide; and optionally (iv) an amount of neonicotinoid insecticide if applied together are more effective in treating a plant or soil against nematode infection than if (i) at the same amount, (ii) at the same amount, (iii) at the same amount and/or (iv) at the same amount is applied alone.

In some embodiments, the amount of anthranilamide compound of formula (I); (ii) an amount of fluensulfone; (iii) an amount of strobilurin fungicide; and (iv) an amount of neonicotinoid insecticide if applied together are more effective in treating a plant or soil against nematode infection than if (i) at the same amount, (ii) at the same amount, (iii) at the same amount and/or (iv) at the same amount is applied alone.

In some embodiments, the mixture is more effective for protecting a plant from fungal attack, preventing fungal infection of the plant or soil, controlling fungal disease infecting the plant or soil, and/or reducing fungal infection of the plant or soil than at least one component of the mixture or combination if is used at its pesticidal effective amount.

In some embodiments, the mixture is more effective for controlling fungal diseases than if (i) at the same amount, (ii) at the same amount, (iii) at the same amount and/or (iv) at the same amount is applied alone.

In some embodiments, the mixture is more effective for controlling insect diseases than if (i) at the same amount, (ii) at the same amount, (iii) at the same amount and/or (iv) at the same amount is applied alone.

In some embodiments, the mixture is more effective for controlling nematodes than if (i) at the same amount, (ii) at the same amount, (iii) at the same amount, and/or (iv) at the same amount is applied alone.

In some embodiments, the, mixture reduces the amount of time needed to achieve a level of pest control compared to when at least one component of the mixture at the same amount is applied alone. An example for reduction is, if azoxystrobin is applied alone achieves 50% control of fungal disease 7 days after application, the mixture or combination disclosed herein achieves 50% control of fungal diseases 2 days after application where each fungicide is applied at the amount.

In some embodiments, the amount of time is reduced by at least 1 day, 2 days, 3 days, 4 day, 5 days, 7 days, 10 days, 14 days or 21 days, or 28 days.

In some embodiments, the mixture is more effective for protecting the plant or soil against fungal attack than if (i) at the same amount, (ii) at the same amount, (iii) at the same amount, and/or (iv) at the same amount is applied alone.

In some embodiments, the mixture prolongs protection against the fungus compared to when least one (i), ii), (iii), (iv) or combination thereof or at the same amount is applied alone.

In some embodiments, protection is prolonged by at least 7 days, 14 days, 21 days, or 28 days.

In some embodiments, the mixture disclosed herein extends the protection period against fungal attack compared to when at least one component of the mixture at the same amount is applied alone.

In some embodiments, the protection period is extended by at least 7 days, 14 days, 21 days, or 28 days.

In some embodiments, the mixture is effective for increasing plant development compared to when at least one component of the mixture at the same amount is applied alone. Increasing plant development includes, but is not limited to, enhancing the root systems, enhancing shoot of the crop plant, enhancing plant vigor and/or enhancing plant potential yield.

In some embodiments, the effective is measured as increased in plant vigor, plant yield, enhancement in root system and/or enhancement in shoot.

In some embodiments, plant vigor is assessed using the relative vigor index. In some embodiments, plant vigor is increased by at least 1%, 5%, 10, 20%, 30%, 40% or 50%.

In some embodiments, enhancement in root system is measured by root weight. In some embodiments, root weight is increased by at least 1%, 5%, 10, 20%, 30%, 40% or 50%.

In some embodiments, enhancement in shoot is measured by shoot weight. In some embodiments, shoot weight is increased by at least 1%, 5%, 10, 20%, 30%, 40% or 50%.

The weight ratio of between the anthranilamide compound of formula (I), fluensulfone, the strobilurin fungicide and the neonicotinoid insecticide cannot generally be defined, as it varies depending upon various conditions such as the type of the formulation, weather conditions, the type of crop and the type of pests.

In one embodiment, the weight ratio of the anthranilamide compound of formula (I) to fluensulfone is from about 1:100 to 100:1. In another embodiment, the weight ratio of the anthranilamide compound of formula (I) to fluensulfone is from about 1:25 to 25:1. In yet another embodiment, the weight ratio of the anthranilamide compound of formula (I) to fluensulfone is from about 1:10 to 10:1. In a further embodiment, the weight ratio of the anthranilamide compound of formula (I) to fluensulfone is from about 1:10 to 1:1. In a further embodiment, the weight ratio of the anthranilamide compound of formula (I) to fluensulfone is from about 1:4.

In some embodiments, In a further embodiment, the weight of the anthranilamide compound of formula (I) in the mixture is 55 g/l and the amount fluensulfone is 240 g/l.

In some embodiments, in a further embodiment, the weight of the anthranilamide compound of formula (I) in the mixture is 64 g/l, the amount fluensulfone is 160 g/l and the amount of azoxystrobin is 19 g/l.

In a further embodiment, the weight ratio of the chlorantraniliprole to fluensulfone is from about 1:4.

In some embodiments, In a further embodiment, the weight of the chlorantraniliprole in the mixture is 55 g/l and the amount fluensulfone is 240 g/l.

In some embodiments, In a further embodiment, the weight of the chlorantraniliprole in the mixture is 64 g/l, the amount fluensulfone is 160 g/l and the amount of azoxystrobin is 19 g/l.

The weight ratio of the anthranilamide compound of formula (I) to fluensulfone may be an intermediate range selected from the above indicated ratios.

In one embodiment, the weight ratio of the anthranilamide compound of formula (I), fluensulfone and the strobilurin fungicide is from about 1-100:1-100:1-100. In another embodiment, the weight ratio of the anthranilamide compound of formula (I), fluensulfone and the strobilurin fungicide is from about 1-50:1-50:1-500. In yet another embodiment, the weight ratio of the anthranilamide compound of formula (I), fluensulfone and the strobilurin fungicide is from about 1-10:1-20:1-10. In a further embodiment, the weight ratio of the anthranilamide compound of formula (I), fluensulfone and the strobilurin fungicide is from about 1.75:8:1.

The weight ratio of the anthranilamide compound of formula (I), fluensulfone and the strobilurin fungicide may be an intermediate range selected from the above indicated ratios.

In one embodiment, the weight ratio of the anthranilamide compound of formula (I), fluensulfone and the neonicotinoid insecticide is from about 1-100:1-100:1-100. In another embodiment, the weight ratio of the anthranilamide compound of formula (I), fluensulfone and the neonicotinoid insecticide is from about 1-50:1-50:1-500. In yet another embodiment, the weight ratio of the anthranilamide compound of formula (I), fluensulfone and the neonicotinoid insecticide is from about 1-10:1-20:1-15. In a further embodiment, the weight ratio of the anthranilamide compound of formula (I), fluensulfone and the neonicotinoid insecticide is from about 1:4.6:1.7.

The weight ratio of the anthranilamide compound of formula (I), fluensulfone and the neonicotinoid insecticide may be an intermediate range selected from the above indicated ratios.

In one embodiment, the weight ratio of the anthranilamide compound of formula (I), fluensulfone, the strobilurin fungicide and the neonicotinoid insecticide is from about 1-100:1-100:1-100:1-100. In another embodiment, the weight ratio of the anthranilamide compound of formula (I), fluensulfone, the strobilurin fungicide and the neonicotinoid insecticide is from about 1-50:1-50:1-500:1-50. In yet another embodiment, the weight ratio of the anthranilamide compound of formula (I), fluensulfone, the strobilurin fungicide and the neonicotinoid insecticide is from about 1-10:1-20: 1-10:1-15. In a further embodiment, the weight ratio of the anthranilamide compound of formula (I), fluensulfone, the strobilurin fungicide and the neonicotinoid insecticide is from about 1.75:8:1:3.

In some embodiments, the weight ration of Azoxystrobin:FluensulfoneChlorantraniliprole:Thiamethoxam is about 1:8:1.75:3.

The weight ratio of the anthranilamide compound of formula (I), fluensulfone, the strobilurin fungicide and the neonicotinoid insecticide may be an intermediate range selected from the above indicated ratios.

Application of the inventive compositions to plants may also lead to an increase in the crop yield.

The pesticidal mixture may be applied via in furrow spray, foliar application, broadcast, basal application, soil application, soil incorporation or soil injection. The pesticidal mixtures can be applied can be applied in the early stages of the crop cycle, such as for example pre-sowing or post-sowing of the crop.

In an embodiment, the mixtures or the compositions disclosed herein are applied to crops which include for example sugar cane (plant or rattan).

The methods of the present invention refer to any crop plants, including but not limited to monocotyledons such as sugar cane, cereals, rice, maize (corn), and/or; or dicotyledon crop such as beets (such as sugar beet or fodder beet); fruits (such as pomes, stone fruits, or soft fruits, for example apples, pears, plums, peaches, almonds, cherries, strawberries, raspberries, or blackberries); leguminous plants (such as beans, lentils, peas, or soybeans); oil plants (such as rape, mustard, poppy, olives, sunflowers, coconut, castor oil plants, cocoa beans, or groundnuts); cucumber plants (such as marrows, cucumbers or melons); fiber plants (such as cotton, flax, hemp, or jute); citrus fruits (such as oranges, lemons, grapefruit, or mandarins); vegetables (such as spinach, lettuce, cabbages, carrots, tomatoes, potatoes, cucurbits, or paprika); lauraceae (such as avocados, cinnamon, or camphor); tobacco; nuts; coffee; tea; vines; hops; durian; bananas; natural rubber plants; and ornamentals (such as flowers, shrubs, broad-leaved trees, or evergreens, for example conifers).

In one embodiment the plants are monocotyledonous plants, more preferably, cereals, in particular wheat or barley. In a specific embodiment, the cereal crop is wheat. In another specific embodiment, the cereal crop is triticale. In another specific embodiment, the cereal crop is rye. In another specific embodiment, the cereal crop is oat. In a further embodiment, the cereal crop is barley. In another embodiment, the crop plants are rice plants. In still another embodiment, the crop plants are sugar cane plants. In yet another embodiment, the crop plants are corn plants.

In some embodiments, the sugar cane is plant cane.

In some embodiments, the sugar cane is ratoon sugarcane.

In another embodiment, the crop plants are dicotyledonous plants. In one embodiment, the crop plants are oil seed rape plants.

The methods of the present invention refer to any plant and/or soil diseases, including but not limited to Sugarcane weevil (Sphenophorus levis), Lesion nematode (Pratylenchus zeae), Root Knot nematode (Meloidogyne javanica), Black root rot (Thielaviopsis paradoxa), and Heterotermes tenuis and Ceratocystis paradoxa.

In some embodiments, the method is effective on plant and/or root system affected by plant and/or soil diseases, including but not limited to plant and/or soil diseases caused by Sugarcane weevil (Sphenophorus levis), Lesion nematode (Pratylenchus zeae), Root Knot nematode (Meloidogyne javanica), Black root rot (Thielaviopsis paradoxa), and Heterotermes tenuis and Ceratocystis paradoxa.

In some embodiments, the method, the mixtures and the compositions disclosed herein is effective on plant and/or root system affected by plant and/or soil diseases caused by Sugarcane weevil (Sphenophorus levis), Lesion nematode (Pratylenchus zeae), Root Knot nematode (Meloidogyne javanica), Heterotermes tenuis and Ceratocystis paradoxa. In an embodiment, the pests may include but are not limited to nematodes, insects and fungi. Some examples include but are not limited to Meloidogyne javanica, Pratylenchus zaea, Sphenophurus levis, Diatraea sacharalis and Ceratocystis paradoxa and Mahanarva fimbriolata.

In some embodiments, the insects include but not limited to Spodoptera sp., Mahanarva sp., Sphenophorus sp., Heterotermes sp., Cornitermes sp., Nasutitermes sp., Procornitermes sp., Neocapritermes sp., Eupalamides sp., Leucocastina sp. and Telchin sp.

In some embodiments, the pathogen includes but is not limited to Puccinia sp., Ustilago sp., Cercospora sp., Ceratocystis sp., Colletotrichum sp. and Fusarium sp.

In still another embodiment, the plants include cultivated plants which tolerate the action of herbicides, fungicides or insecticides as a result of breeding and/or genetically engineered methods.

In a further embodiment, the mixture is applied in non-crop areas which include but are not limited to, turfgrass, pastures, grasslands, rangelands, fallow land, rights-of-way, golf courses, parks, along roadsides, power-lines, pipelines, railways, forests, well sites, and equipment yards.

The effective application rates of the anthranilamide compound of formula (I), fluensulfone, the strobilurin fungicide and the neonicotinoid insecticide cannot generally be defined, as it varies depending upon various conditions such as the type of the formulation, weather conditions, the type of crop and the type of pests.

In an embodiment, the present mixtures contain 1-100 g/l of an anthranilamide compound of formula (I), and 200-500 g/l of fluensulfone. In another embodiment, the present mixtures contain 1-75 g/l of an anthranilamide compound of formula (I), and 200-300 g/l of fluensulfone. In a specific embodiment, the present mixtures contain 55 g/l of chlorantraniliprole, and 240 g/l of fluensulfone.

In an embodiment, the present mixtures contain 1-100 g/l of an anthranilamide compound of formula (I), 200-500 g/l of fluensulfone, 1-100 g/l of a strobilurin fungicide and 1-150 g/l of a neonicotinoid insecticide. In another embodiment, the present mixtures contain 1-50 g/l of an anthranilamide compound of formula (I), 100-300 g/l of fluensulfone, 1-100 g/l of a strobilurin fungicide and 1-150 g/l of a neonicotinoid insecticide. In a specific embodiment, the present mixtures contain 35 g/l of chlorantraniliprole, and 160 g/l of fluensulfone, 20 g/l of azoxystrobin and 60 g/l of thiamethoxam.

The application rates of the mixture or combination may vary, depending on the desired effect. In an embodiment, depending on the desired effect, the application rates of the mixture according to the invention are from 1 g/ha to 10000 g/ha, particularly from 50 to 5000 g/ha, more particularly from 100 to 2000 g/ha. In another embodiment, the application rate of the mixture according to the invention are from 500 g/ha to 1000 g/ha.

Correspondingly, the application rates for the anthranilamide compound of formula (I) are generally from 1 to 1000 g/ha.

Correspondingly, the application rates for fluensulfone are generally from 1 to 1000 g/ha.

Correspondingly, the application rates for the strobilurin fungicide are generally from 1 to 2500 g/ha, preferably from 10 to 1500 g/ha, in particular from 600 to 1000 g/ha.

Correspondingly, the application rates for the neonicotinoid insecticide are generally from 1 to 1000 g/ha.

In another embodiment, the anthranilamide compound of formula (I), and fluesulfone can be applied simultaneously, that is jointly or separately, or in succession, the sequence, in the case of separate application, generally not having any effect on the result of the control measures.

That is, each of the anthranilamide compound of formula (I), and fluensulfone may be applied jointly or in succession. In one example, the anthranilamide compound of formula (I), and fluensulfone are prepared separately, and the individual formulations are applied as is, or diluted to predetermined concentrations. In a further example, the anthranilamide compound of formula (I), and fluensulfone are prepared separately, and the formulations are mixed when diluted to a predetermined concentration. In another example, the anthranilamide compound of formula (I), and fluensulfone are formulated together, and the formulation is applied as it is, or the formulation is diluted to a predetermined concentration.

For example, chlorantraniliprole, and fluensulfone can be applied simultaneously, that is jointly or separately, or in succession, the sequence, in the case of separate application, generally not having any effect on the result of the control measures. In one example, chlorantraniliprole, and fluensulfone are prepared separately, and the individual formulations are applied as is, or diluted to predetermined concentrations. In a further example, chlorantraniliprole, and fluensulfone are prepared separately, and the formulations are mixed when diluted to a predetermined concentration. In another example, chlorantraniliprole, and fluensulfone are formulated together, and the formulation is applied as it is, or the formulation is diluted to a predetermined concentration.

That is, each of the anthranilamide compound of formula (I), fluensulfone, the strobilurin fungicide and the neonicotinoid insecticide may be applied jointly or in succession. In one example, the anthranilamide compound of formula (I), fluensulfone, the strobilurin fungicide and the neonicotinoid insecticide are prepared separately, and the individual formulations are applied as is, or diluted to predetermined concentrations. In a further example, the anthranilamide compound of formula (I), fluensulfone, the strobilurin fungicide and the neonicotinoid insecticide are prepared separately, and the formulations are mixed when diluted to a predetermined concentration. In another example, the anthranilamide compound of formula (I), fluensulfone, the strobilurin fungicide and the neonicotinoid insecticide are formulated together, and the formulation is applied as it is, or the formulation is diluted to a predetermined concentration.

For example, chlorantraniliprole, fluensulfone, azoxystrobin and thiamethoxam can be applied simultaneously, that is jointly or separately, or in succession, the sequence, in the case of separate application, generally not having any effect on the result of the control measures. In one example, chlorantraniliprole, fluensulfone, azoxystrobin and thiamethoxam are prepared separately, and the individual formulations are applied as is, or diluted to predetermined concentrations. In a further example, chlorantraniliprole, fluensulfone, azoxystrobin and thiamethoxam are prepared separately, and the compositions are mixed when diluted to a predetermined concentration. In another example, chlorantraniliprole, fluensulfone, azoxystrobin and thiamethoxam are formulated together, and the formulation is applied as it is, or the formulation is diluted to a predetermined concentration.

The present invention provides a composition comprising any mixture or combination described herein.

The present invention provides a composition comprising i) an anthranilamide compound of formula (I); (ii) fluensulfone; optionally (iii) a strobilurin fungicide; and further optionally (iv) a neonicotinoid insecticide.

The present invention provides a composition comprising i) an anthranilamide compound of formula (I); (ii) fluensulfone; (iii) a strobilurin fungicide; and (iv) a neonicotinoid insecticide.

The present invention provides a composition comprising i) an amount of anthranilamide compound of formula (I); (ii) an amount of fluensulfone; optionally (iii) an amount of strobilurin fungicide; and further optionally (iv) an amount of neonicotinoid insecticide.

The present invention provides a composition comprising i) an amount of anthranilamide compound of formula (I); (ii) an amount of fluensulfone; and (iii) an amount of strobilurin fungicide.

The present invention provides a composition comprising i) an amount of anthranilamide compound of formula (I); (ii) an amount of fluensulfone; and (iv) an amount of neonicotinoid insecticide.

The present subject matter relates to composition comprising: (i) chlorantraniliprole; (ii) fluensulfone; (iii) azoxystrobin and (iv) thiamethoxam.

The present subject matter relates to composition comprising: (i) chlorantraniliprole; (ii) fluensulfone; and (iii) a azoxystrobin.

The present subject matter relates to composition comprising: (i) chlorantraniliprole (ii) fluensulfone; and (iv) thiamethoxam.

The present subject matter relates to composition comprising: (i) chlorantraniliprole; (ii) fluensulfone.

The present invention provides a composition comprising i) an amount of anthranilamide compound of formula (I); (ii) an amount of fluensulfone; (iii) an amount of strobilurin fungicide; and (iv) an amount of neonicotinoid insecticide.

In some embodiments, the composition is more effective than if (i) at the same amount, (ii) at the same amount, (iii) at the same amount, and/or (iv) at the same amount is applied alone

In some embodiments, components of the mixture or composition of the present disclosure are applied at least one time during a growth season.

In some embodiments, the components of the mixture or composition of the present disclosure are applied two or more times during a growth season.

In some embodiments, the components of the mixture or composition of the present disclosure are applied as a soil application. In some embodiments, the mixtures and/or compositions described herein are applied as a foliar application. In some embodiments, the components of the mixture or the composition thereof are applied as seed treatment.

In some embodiments, the components of the mixture or composition of the present disclosure are applied as a soil application, as a foliar application, as seed treatment and any combination thereof.

In some embodiments, the mixture or composition of the present disclosure is applied at least one time during a growth season.

In some embodiments, the, mixture or composition of the present disclosure is applied two or more times during a growth season. In some embodiments, the mixture or composition described herein are applied as a soil application. In some embodiments, the combination, mixture or composition described herein are applied as a foliar application.

In some embodiments, the composition is a synergistic composition.

In yet another embodiment, the synergistic composition may be applied in various mixtures or combinations of the anthranilamide compound of formula (I), and fluensulfone, for example in a single “ready-for-use” form, or in a combined spray mixture composed from separate formulations of the single active ingredients, such as a “tank-mix” form.

In a further embodiment, the synergistic composition may be applied in various mixtures or combinations of the anthranilamide compound of formula (I), fluensulfone, the strobilurin fungicide and the neonicotinoid insecticide, for example in a single “ready-for-use” form, or in a combined spray mixture composed from separate formulations of the single active ingredients, such as a “tank-mix” form.

In yet another embodiment, the composition is applied in the form of a ready-for-use formulation comprising the anthranilamide compound of formula (I) (e.g. chlorantraniliprole), and fluensulfone. This formulation can be obtained by combining the active ingredients in an effective amount with an agriculturally acceptable carrier, a surfactant or other application-promoting adjuvant customarily employed in formulation technology.

In yet another embodiment, the composition is applied in the form of a ready-for-use formulation comprising the anthranilamide compound of formula (I) (e.g. chlorantraniliprole), fluensulfone, the strobilurin fungicide (e.g. azoxystrobin) and the neonicotinoid insecticide (e.g. thiamethoxam). This formulation can be obtained by combining the active ingredients in an effective amount with an agriculturally acceptable carrier, a surfactant or other application-promoting adjuvant customarily employed in formulation technology.

For example, the composition of the present invention is preferably applied in the form of a ready-for-use formulation comprising bifenthrin, acetamiprid and acephate, which can be obtained by combining the three active ingredients with an agriculturally acceptable carrier, a surfactant or other application-promoting adjuvant customarily employed in formulation technology.

The present composition may be employed or prepared in any conventional form, for example, as wettable powders (WP), emulsion concentrates (EC), microemulsion concentrates (MEC), water-soluble powders (SP), water-soluble concentrates (SL), suspoemulsion (SE), oil dispersions (OD), concentrated emulsions (BW) such as oil-in-water and water-in-oil emulsions, sprayable solutions or emulsions, capsule suspensions (CS), suspension concentrates (SC), suspension concentrates, dusts (DP), oil-miscible solutions (OL), seed-dressing products, granules (GR) in the form of microgranules, spray granules, coated granules and absorption granules, granules for soil application or broadcasting, water-soluble granules (SG), water-dispersible granules (WDG), ULV formulations, microcapsules or waxes. These individual formulation types are known in the art.

According to an embodiment, the composition comprises at least one additional component selected from the group of surfactants, solid diluents and liquid diluents.

Such compositions can be formulated using agriculturally acceptable carriers, surfactants or other application-promoting adjuvants customarily employed in formulation technology and formulation techniques that are known in the art.

Examples of suitable liquid carriers potentially useful in the present compositions include but are not limited to water; aromatic hydrocarbons such as alkylbenzenes and alkylnaphthalenes; alcohols such as cyclohexanol, and decanol; ethylene glycol; polypropylene glycol; dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

Examples of suitable solid carriers potentially useful in the present compositions include but are not limited to mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

Examples of suitable surfactants include, but are not limited to, non-ionic, anionic, cationic and ampholytic types such as alkoxylated fatty alcohols, ethoxylated polysorbate (e.g. tween 20), ethoxylated castor oil, lignin sulfonates, fatty acid sulfonates (e.g. lauryl sulfonate), phosphate esters such as phosphate esters of alcohol alkoxylates, phosphate esters of alkylphenol alkoxylates and phosphate esters of styrylphenol ethoxylates, condensates of sulfonated naphthalene and naphthalene derivatives with formaldehyde, condensates of naphthalene or of naphthalenesulfonic acid with phenol and formaldehyde, alkylarylsulfonates, ethoxylated alkylphenols and aryl phenols, polyalkylene glycols, sorbitol esters, alkali metal, sodium salts of lignosulphonates, tristyrylphenol ethoxylate phosphate esters, aliphatic alcohol ethoxylates, alkylphenol ethoxylates, ethylene oxide/propylene oxide block copolymers, graft copolymers and polyvinyl alcohol-vinyl acetate copolymers. Other surfactants known in the art may be used as desired.

Other ingredients, such as wetting agents, anti-foaming, adhesives, neutralizers, thickeners, binders, sequestrates, fertilizers, biocides, stabilizers, buffers or anti-freeze agents, may also be added to the present compositions in order to increase the stability, density, and viscosity of the described compositions.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier. Alternatively, it is also possible to prepare concentrates comprising active ingredient, wetting agent, tackifier, dispersant or emulsifier and, if desired, a solvent or oil, which are suitable for dilution with water.

In an embodiment, the amount of the mixture of active ingredients in the composition is about 0.1-99 wt. %, about 0.1-95 wt. %, or about 0.1-90 wt. %, based on the total weight of the composition. In another embodiment, the amount of the mixture of active ingredients in the composition is about 1-70 wt. %, based on the total weight of the composition. In yet another embodiment, the amount of the mixture of active ingredients in the composition is about 1-50 wt. %, based on the total weight of the composition. In yet another embodiment, the amount of the mixture of active ingredients in the composition is about 1-40 wt. %, based on the total weight of the composition. In yet another embodiment, the amount of the mixture of active ingredients in the composition is about 1-30 wt. %, based on the total weight of the composition. In yet another embodiment, the amount of the mixture of active ingredients in the composition is about 1-20 wt. %, based on the total weight of the composition. In yet another embodiment, the amount of the mixture of active ingredients in the composition is about 1-10 wt. %, based on the total weight of the composition. The remaining components in the formulation are for example the carrier and additives.

In an embodiment, the amount of the mixture of active ingredients in the composition is from about 0.1%, 0.5%%, 1%, 1.5%, 2%, 2.5%, 3%, 3.5%, 4%, 4.5%, 5% to about 90%, 93%, 95%, 98%, 99% based on the total weight of the composition.

The present composition may include additional crop protection agents, for example insecticides, herbicides, fungicides, bactericides, nematicides, molluscicides, growth regulators, biological agents, fertilizers, or mixtures thereof. However, for the avoidance of doubt it is understood that such additional crop protection agents are unnecessary to achieve the desired control of pests as achieved by the present combinations.

In another embodiment, the present invention provides a kit comprising a binary, ternary or tertiary synergistic pesticidal composition as described herein, or components thereof. Such kits may comprise, in addition to the aforementioned active components, one or more additional active and/or inactive ingredients, either within the provided pesticidal composition or separately.

As noted above, the compositions, kits and methods described herein exhibit a synergistic effect. A synergistic effect exists wherever the action of a combination of active components is greater than the sum of the action of each of the components alone. Therefore, a synergistically effective amount (or an effective amount of a synergistic composition or combination) is an amount that exhibits greater pesticidal activity than the sum of the activities of the individual components.

Method of Use

The present invention provides a method for controlling nematodes comprising applying an effective amount of the any one of the mixtures or the compositions disclosed herein to one or more plants, the locus thereof or propagation material thereof so as to thereby enhance nematode control.

The present invention provides a method for enhancing nematode control comprising applying an effective amount of the any one of the mixtures or the compositions disclosed herein to one or more plants, the locus thereof or propagation material thereof so as to thereby enhance nematode control.

The present invention provides a method for enhancing root systems and/or enhancing crop plants development and/or enhancing crop plants vigor and/or improving plant potential yield comprising applying an effective amount of the any one of the mixtures or compositions disclosed herein to one or more plants, the locus thereof or propagation material thereof.

The present invention provides a method for enhancing plant development comprising applying an effective amount of the any one of the mixtures or the compositions disclosed herein to one or more plants, the locus thereof or propagation material thereof so as to thereby enhance plant development.

The present invention provides a method for enhancing root system comprising applying an effective amount of the any one of the mixtures or the compositions disclosed herein to one or more plants, the locus thereof or propagation material thereof so as to thereby enhance the root system.

The present invention provides a method for enhancing plant vigor comprising applying an effective amount of the any one of the mixtures or the compositions disclosed herein to one or more plants, the locus thereof or propagation material thereof so as to thereby enhance plant vigor.

The present invention provides a method for improving plant potential yield comprising applying an effective amount of the any one of the mixtures or the compositions disclosed herein to one or more plants, the locus thereof or propagation material thereof so as to thereby improve plant potential yield.

The present invention provides a method for regulating plant growth comprising applying an effective amount of the any one of the mixtures or the compositions disclosed herein to one or more plants, the locus thereof or propagation material thereof so as to thereby regulate plant growth.

The present invention provides a method for control of insects by contacting the insect or their food supply, habitat, breeding grounds or their locus with an effective amount of the any one of the mixtures or the compositions disclosed herein so as to thereby control insects.

The present invention provides a method of protecting plants from attack or infestation by insects comprising contacting the plant, or the soil or water in which the plant is growing, with an effective amount of the any one of the mixtures or the compositions disclosed herein so as to thereby protecting plants from attack or infestation by insects.

Biological effect such as controlling nematodes, insect and/or pathogen may be improved by combining chlorantraniliprole, fluensulfone, azoxystrobin and thiamethoxam. Also plant development, including, but not limited to, enhancing the root systems and/or shoot of the crop plant and/or plant vigor and/or plant potential yield may be enhanced by using the present invention mixtures.

In some embodiments, plant vigor is assessed using the relative vigor index. In some embodiments, plant vigor is increased by at least 1%, 5%, 10, 20%, 30%, 40%, 50%, 60%, 70%, 80%, or 90%.

In some embodiments, enhancement in root system is measured by root weight. In some embodiments, root weight is increased by at least 1%, 5%, 10, 20%, 30%, 40%, 50%, 60%, 70%, 80%, or 90%.

In some embodiments, enhancement in shoot is measured by shoot weight. In some embodiments, shoot weight is increased by at least 1%, 5%, 10, 20%, 30%, 40%, 50%, 60%, 70%, 80%, or 90%.

In some embodiments, the mixture, combination, composition or synergistic mixture or composition comprises one or more additional active ingredient (s). In some embodiments, the mixture or synergistic mixture comprises one or more additional non-active ingredient(s).

The present invention provides a method for control of fungal disease comprising applying an effective amount of the any one of the mixtures or the compositions disclosed herein to one or more plants, the locus thereof or propagation material thereof so as to thereby control fungal disease.

In some embodiments, one or more plants is sugarcane.

In some embodiments, the plant is sugarcane.

The following examples illustrate the practice of the present invention in some of its embodiments, but should not be construed as limiting the scope of the invention. Other embodiments will be apparent to one skilled in the art from consideration of the specification and examples. It is intended that the specification, including the examples, is considered exemplary only without limiting the scope and spirit of the invention.

In some embodiments, the mixture or synergistic mixture comprises one or more additional active ingredient (s). In some embodiments, the mixture or synergistic mixture comprises one or more additional non-active ingredient(s).

### Prophetic Examples

Experiments may be carried out to determine the synergistic effect of the pesticidal mixtures and compositions composition which comprises a mixture of a) an anthranilamide compound of formula (I) such as chlorantraniliprole and b) fluensulfone.

A pesticidal composition may be prepared by thoroughly mixing an anthranilamide compound of formula (I) such as chlorantraniliprole (weight %) with fluensulfone (weight %).

Further experiments may be carried out to determine the synergistic effect of the pesticidal mixtures and compositions composition which comprises a mixture of a) an anthranilamide compound of formula (I) such as chlorantraniliprole b) fluensulfone, c) a strobilurin fungicide such as azoxystrobin and d) a neonicotinoid insecticide such as thiamethoxam.

A pesticidal composition may be prepared by thoroughly mixing an anthranilamide compound of formula (I) such as chlorantraniliprole (weight %), fluensulfone (weight %), a strobilurin fungicide such as azoxystrobin (weight %) and a neonicotinoid insecticide such as thiamethoxam (weight %).

Different concentrations of each of the active ingredients may be applied to different pests such as nematodes, insects and fungi. In some examples sugar cane may be infected with at least one of the above pests. The percent control may be determined some time after treatment.

The observed percent control of the pesticidal composition against nematodes is expected to be higher than the expected percentage control according to Colby's equation. Therefore, the pesticidal composition comprising an anthranilamide compound of formula (I) such as chlorantraniliprole (weight %) and fluensulfone (weight %) is expected to show synergistic effect against nematodes.

The observed percent control of the pesticidal composition against nematodes is expected to be higher than the expected percentage control according to Colby's equation. Therefore, the pesticidal composition comprising an anthranilamide compound of formula (I) such as chlorantraniliprole (weight %), fluensulfone (weight %), a strobilurin fungicide such as azoxystrobin (weight %) and a neonicotinoid insecticide such as thiamethoxam (weight %) is expected to show synergistic effect against nematodes.

The observed percent control of the pesticidal composition against insects is expected to be higher than the expected percentage control according to Colby's equation. Therefore, the pesticidal composition comprising an anthranilamide compound of formula (I) such as chlorantraniliprole (weight %) and fluensulfone (weight %) is expected to show synergistic effect against insects.

The observed percent control of the pesticidal composition against insects is expected to be higher than the expected percentage control according to Colby's equation. Therefore, the pesticidal composition comprising an anthranilamide compound of formula (I) such as chlorantraniliprole (weight %), fluensulfone (weight %), a strobilurin fungicide such as azoxystrobin (weight %) and a neonicotinoid insecticide such as thiamethoxam (weight %) is expected to show synergistic effect against insects.

The observed percent control of the pesticidal composition against fungal diseases is expected to be higher than the expected percentage control according to Colby's equation.

Therefore, the pesticidal composition comprising an anthranilamide compound of formula (I) such as chlorantraniliprole (weight %), fluensulfone (weight %), a strobilurin fungicide such as azoxystrobin (weight %) and a neonicotinoid insecticide such as thiamethoxam (weight %) is expected to show synergistic effect against fungal diseases.

A synergistic effect exists whenever the action of an active ingredient combination is greater than the sum of the actions of the individual components.

In some embodiments, the mixture is synergistic for enhancing crop plant. In some embodiments, the mixture is synergistic for enhancing plant development. In some embodiments, the mixture is synergistic for enhancing root system. In some embodiments, the mixture is synergistic for improving plant quality. In some embodiments, the mixture is synergistic for regulating plant growth. In some embodiments, the mixture is synergistic for controlling nematodes.

In the field of agriculture, it is often understood that the term “synergy” is as defined by Colby S. R. in an article entitled “Calculation of the synergistic and antagonistic responses of herbicide combinations” published in the journal Weeds, 1967, 15, p. 20-22. The action expected for a given combination of two active components can be calculated as follows:

$$E = X + Y - \frac{XY}{100}$$

The action expected for a given combination of three active components can be calculated as follows:

$$E = X + Y + Z - \frac{XY + XZ + YZ}{100} + \frac{XYZ}{10000}$$

The action expected for a given combination of four active components can be calculated as follows:

$$E = X + Y + Z + W - \frac{XY + XZ + XW + YZ + YW + ZW}{100} + \frac{XYZ + XYW + XZW + YZW}{10000} - \frac{XYZW}{1000000}$$

in which E represents the expected effect, e.g. percentage of pest control, for the combination of the active ingredients at defined doses (for example equal to x, y, z and w respectively), X is the effect, e.g. percentage of pest control, observed for compound (I) at a defined dose (equal to x), Y is the effect, e.g. percentage of pest control, observed for compound (II) at a defined dose (equal to y), Z is the effect, e.g. percentage of pest control, observed for compound (III) at a defined dose (equal to z), W is the effect, e.g. percentage of pest control, observed for compound (IV) at a defined dose (equal to w). Here, efficacy or percent inhibition is determined in %. 0% means efficacy that corresponds to the Control, i.e., as if no treatment had been applied. Whereas, a percent inhibition of 100% means that no infection is observed. When the percent inhibition observed for the combination is greater than E, there is a synergistic effect. When the percent inhibition observed for the combination is equal to E, there is an additive effect and wherein the percent inhibition observed for the combination is lower than E, there is an antagonistic effect.

While the present disclosure may be susceptible to various modifications and alternative forms, specific embodiments have been described by way of example in detail herein. However, it should be understood that the present disclosure is not intended to be limited to the particular forms disclosed. Rather, the present disclosure is to cover all modifications, equivalents, and alternatives falling within the scope of the present disclosure as defined by the following appended claims and their legal equivalents.

In addition, any priority document(s) of this application is/are hereby incorporated herein by reference in its/their entirety.

1. A pesticidal mixture comprising: (i) an anthranilamide compound of formula (I) 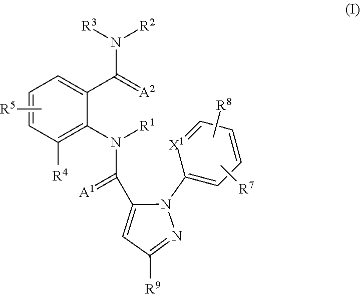
in which
A¹ and A² independently of one another represent oxygen or sulfur,
X¹ represents N or CR¹⁰,
R¹ represents hydrogen or represents C₁-C₆-alkyl, C₂-C₆-alkenyl, C₂-C₆-alkynyl or C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-alkylthio, C₁-C₄-alkylsulfinyl, C₁-C₄-alkylsulfonyl, C₂-C₄-alkoxycarbonyl, C₁-C₄-alkylamino, C₂-C₈-dialkylamino, C₃-C₆-cycloalkylamino, (C₁-C₄-alkyl)-C₃-C₆-cycloalkylamino and R¹¹,
R² represents hydrogen, C₁-C₆-alkyl, C₂-C₆-alkenyl, C₂-C₆-alkynyl, C₃-C₆-cycloalkyl, C₁-C₄-alkoxy, C₁-C₄-alkylamino, C₂-C₈-dialkylamino, C₃-C₆-cycloalkylamino, C₂-C₆-alkoxycarbonyl or C₂-C₆-alkylcarbonyl,
R³ represents hydrogen, R¹¹ or represents C₁-C₆-alkyl, C₂-C₆-alkenyl, C₂-C₆-alkynyl, C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₂-C₆-alkoxycarbonyl, C₂-C₆-alkylcarbonyl, C₃-C₆-trialkylsilyl, R¹¹, phenyl, phenoxy and a 5- or 6-membered heteroaromatic ring, where each phenyl, phenoxy and 5- or 6-membered heteroaromatic ring may optionally be substituted and where the substituents independently of one another may be selected from one to three radicals W or one or more radicals R¹², or
R² and R³ may be attached to one another and form the ring M,
R⁴ represents hydrogen, C₁-C₆-alkyl, C₂-C₆-alkenyl, C₂-C₆-alkynyl, C₃-C₆-cycloalkyl, C₁-C₆-haloalkyl, C₂-C₆-haloalkenyl, C₂-C₆-haloalkynyl, C₃-C₆-halocycloalkyl, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-cycloalkylamino, C₃-C₆-trialkylsilyl or represents phenyl, benzyl or phenoxy, each of which is optionally mono- or polysubstituted, where the substituents independently of one another may be selected from the group consisting of C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfinyl, C₁-C₄-alkylsulfonyl, C₁-C₄-alkylamino, C₂-C₈-dialkylamino, C₃-C₆-cycloalkylamino, C₃-C₆-(alkyl)cycloalkylamino, C₂-C₄-alkylcarbonyl, C₂-C₆-alkoxycarbonyl, C₂-C₆-alkylaminocarbonyl, C₃-C₈-dialkylaminocarbonyl and C₃-C₆-trialkylsilyl,
R⁵ and R⁸ in each case independently of one another represent hydrogen, halogen or represent in each case optionally substituted C₁-C₄-alkyl, C₁-C₄-haloalkyl, R¹², G, J, —OJ, —OG, —S(O)ₚ-J, —S(O)ₚG, —S(O)ₚ-phenyl, where the substituents independently of one another may be selected from one to three radicals W or from the group consisting of R¹², C₁-C₁₀-alkyl, C₂-C₆-alkenyl, C₂-C₆-alkynyl, C₁-C₄-alkoxy and C₁-C₄-alkylthio, where each substituent may be substituted by one or more substituents independently of one another selected from the group consisting of G, J,
R⁶, halogen, cyano, nitro, amino, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-trialkylsilyl, phenyl and phenoxy, where each phenyl or phenoxy ring may optionally be substituted and where the substituents independently of one another may be selected from one to three radicals W or one or more radicals R¹²,
G in each case independently of one another represents a 5- or 6-membered non-aromatic carbocyclic or heterocyclic ring which may optionally contain one or two ring members from the group consisting of C(═O), SO and S(═O)₂ and which may optionally be substituted by one to four substituents independently of one another selected from the group consisting of C₁-C₂-alkyl, halogen, cyano, nitro and C₁-C₂-alkoxy, or independently of one another represents C₂-C₆-alkenyl, C₂-C₆-alkynyl, C₃-C₇-cycloalkyl, (cyano)-C₃-C₇-cycloalkyl, (C₁-C₄-alkyl)-C₃-C₆-cycloalkyl, (C₃-C₆-cycloalkyl)-C₁-C₄-alkyl, where each cycloalkyl, (alkyl)cycloalkyl and (cycloalkyl)alkyl may optionally be substituted by one or more halogen atoms,
J in each case independently of one another represents an optionally substituted 5- or 6-membered heteroaromatic ring, where the substituents independently of one another may be selected from one to three radicals W or one or more radicals R¹²,
R⁶ independently of one another represents —C(=E¹)R¹⁹, -L(=E¹)R¹⁹, —C(=E¹)LR¹⁹, -LC(=E¹)LR¹⁹, —OP(=Q)(OR¹⁹)₂, —SO₂LR¹⁸ or -LSO₂LR¹⁹, where each E¹ independently of one another represents O, S, N—R¹⁵, N—OR¹⁵, N—N(R¹⁵)₂, N—S═O, N—CN or N—NO₂,
R⁷ represents hydrogen, C₁-C₄-alkyl, C₁-C₄-haloalkyl, halogen, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl,
R⁹ represents C₁-C₄-haloalkyl, C₁-C₄-haloalkoxy, C₁-C₄-haloalkylsulfinyl or halogen,
R¹⁰ represents hydrogen, C₁-C₄-alkyl, C₁-C₄-haloalkyl, halogen, cyano or C₁-C₄-haloalkoxy,
R¹¹ in each case independently of one another represents in each case optionally mono- to trisubstituted C₁-C₆-alkylthio, C₁-C₆-alkylsulfenyl, C₁-C₆-haloalkylthio, C₁-C₆-haloalkylsulfenyl, phenylthio or phenylsulfenyl, where the substituents independently of one another may be selected from the list W, —S(O)ₙN(R¹⁶)₂, —C(═O)R¹³, -L(C═O)R¹⁴, —S(C═O)LR¹⁴, —C(═O)LR¹³, —S(O)ₙNR¹³C(═O)R¹³, —S(O)ₙNR¹³C(═O)LR¹⁴ or —S(O)ₙNR¹³S(O)₂LR¹⁴,
L in each case independently of one another represents O, NR¹⁸ or S,
R¹² in each case independently of one another represents —B(OR¹⁷)₂, amino, SH, thiocyanato, C₃-C₈-trialkylsilyloxy, C₁-C₄-alkyl disulfides, —SF₅, —C(=E)R¹⁹, -LC(=E¹)R¹⁹, —C(=E¹)LR¹⁹, -LC(=E¹)LR¹⁹, —OP(=Q)(OR⁹)₂, —SO₂LR¹⁹ or -LSO₂LR¹⁹,
Q represents O or S,
R¹³ in each case independently of one another represents hydrogen or represents in each case optionally mono- or polysubstituted C₁-C₆-alkyl, C₂-C₆-alkenyl, C₂-C₆-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino or (C₁-C₄-alkyl)-C₃-C₆-cycloalkylamino,
R¹⁴ in each case independently of one another represents in each case optionally mono- or polysubstituted C₂-C₂₀-alkenyl, C₂-C₂₀-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino and (C₁-C₄-alkyl)-C₃-C₆-cycloalkylamino or represent optionally substituted phenyl, where the substituents independently of one another may be selected from one to three radicals W or one or more radicals R¹²,
R¹⁵ in each case independently of one another represents hydrogen or represents in each case optionally mono- or polysubstituted C₁-C₆-haloalkyl or C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₂-C₆-alkoxycarbonyl, C₂-C₆-alkylcarbonyl, C₃-C₆-trialkylsilyl and optionally substituted phenyl, where the substituents independently of one another may be selected from one to three radicals W or one or more radicals R¹², or N(R¹⁵)₂ represents a cycle which forms the ring M,
R¹⁶ represents C₁-C₁₂-alkyl or C₁-C₁₂-haloalkyl, or N(R¹⁶)₂ represents a cycle which forms the ring M,
R¹⁷ in each case independently of one another represents hydrogen or C₁-C₄-alkyl, or B(OR¹⁷)₂ represents a ring in which the two oxygen atoms are attached via a chain having two to three carbon atoms which are optionally substituted by one or two substituents independently of one another selected from the group consisting of methyl and C₂-C₆-alkoxycarbonyl,
R¹⁸ in each case independently of one another represents hydrogen, C₁-C₆-alkyl or C₁-C₆-haloalkyl, or N(R¹³)(R⁸) represents a cycle which forms the ring M,
R¹⁹ in each case independently of one another represents hydrogen or represents in each case mono- or polysubstituted C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, CO₂H, C₂-C₆-alkoxycarbonyl, C₂-C₆-alkylcarbonyl, C₃-C₆-trialkylsilyl and optionally substituted phenyl, where the substituents independently of one another may be selected from one to three radicals W, C₁-C₆-haloalkyl, C₃-C₆-cycloalkyl or phenyl or pyridyl, each of which is optionally mono- to trisubstituted by W,
M in each case represents an optionally mono- to tetrasubstituted ring which, in addition to the nitrogen atom attached to the substituent pair R¹³ and R¹⁸, (R¹⁵)₂ or (R¹⁶)₂, contains two to six carbon atoms and optionally additionally a further nitrogen, sulfur or oxygen atom, where the substituents independently of one another may be selected from the group consisting of C₁-C₂-alkyl, halogen, cyano, nitro and C₁-C₂-alkoxy,
W in each case independently of one another represents C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfonyl, C₁-C₄-alkylamino, C₂-C₈-dialkylamino, C₃-C₆-cycloalkylamino, (C₁-C₄-alkyl)-C₃-C₆-cycloalkylamino, C₂-C₄-alkylcarbonyl, C₂-C₆-alkoxycarbonyl, CO₂H, C₂-C₆-alkylaminocarbonyl, C₃-C₈-dialkylaminocarbonyl or C₃-C₆-trialkylsilyl,
n in each case independently of one another represents 0 or 1,
p in each case independently of one another represents 0, 1 or 2,
where, if (a) R⁵ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio or halogen and (b) R⁸ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio, halogen, C₂-C₄-alkylcarbonyl, C₂-C₆-alkoxycarbonyl, C₂-C₆-alkylaminocarbonyl or C₃-C₈ dialkylaminocarbonyl, (c) at least one substituent selected from the group consisting of R⁶, R¹¹ and R¹² if present and (d) if R¹² is not present, at least one of the radicals R⁶ and R¹¹ is different from C₂-C₆-alkylcarbonyl, C₂-C₆-alkoxycarbonyl, C₂-C₆-alkylaminocarbonyl and C₃-C₈-dialkylaminocarbonyl, and where the compound of the general formula (I) may also be an N-oxide or salt;
(ii) fluensulfone; optionally (iii) a strobilurin fungicide; and further optionally (iv) a neonicotinoid insecticide.

2. The pesticidal mixture of claim 1, wherein the mixture comprises (iii) a strobilurin fungicide.

3. The pesticidal mixture of claim 1, wherein the mixture comprises (iii) a neonicotinoid insecticide.

4. The pesticidal mixture of claim 1, wherein the mixture exhibits synergistic effects.

5. The pesticidal mixture of claim 1, wherein the anthranilamide compound of formula (I), fluensulfone, and optionally the strobilurin fungicide and/or the neonicotinoid insecticide are applied jointly or in a succession.

6. A pesticidal mixture comprising: (i) an anthranilamide compound of formula (I) 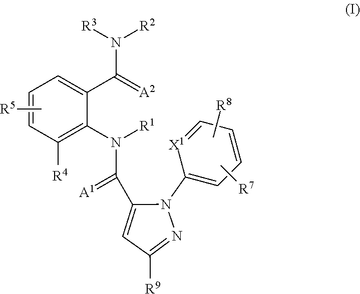
in which
A¹ and A² independently of one another represent oxygen or sulfur,
X represents N or CR¹⁰,
R¹ represents hydrogen or represents C₁-C₆-alkyl, C₂-C₆-alkenyl, C₂-C₆-alkynyl or C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-alkylthio, C₁-C₄-alkylsulfinyl, C₁-C₄-alkylsulfonyl, C₂-C₄-alkoxycarbonyl, C₁-C₄-alkylamino, C₂-C₈-dialkylamino, C₃-C₆-cycloalkylamino, (C₁-C₄-alkyl)-C₃-C₆-cycloalkylamino and R¹¹,
R² represents hydrogen, C₁-C₆-alkyl, C₂-C₆-alkenyl, C₂-C₆-alkynyl, C₃-C₆-cycloalkyl, C₁-C₄-alkoxy, C₁-C₄-alkylamino, C₂-C₈-dialkylamino, C₃-C₆-cycloalkylamino, C₂-C₆-alkoxycarbonyl or C₂-C₆-alkylcarbonyl,
R³ represents hydrogen, R¹¹ or represents C₁-C₆-alkyl, C₂-C₆-alkenyl, C₂-C₆-alkynyl, C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₂-C₆-alkoxycarbonyl, C₂-C₆-alkylcarbonyl, C₃-C₆-trialkylsilyl, R¹¹, phenyl, phenoxy and a 5- or 6-membered heteroaromatic ring, where each phenyl, phenoxy and 5- or 6-membered heteroaromatic ring may optionally be substituted and where the substituents independently of one another may be selected from one to three radicals W or one or more radicals R¹², or
R² and R³ may be attached to one another and form the ring M,
R⁴ represents hydrogen, C₁-C₆-alkyl, C₂-C₆-alkenyl, C₂-C₆-alkynyl, C₃-C₆-cycloalkyl, C₁-C₆-haloalkyl, C₂-C₆-haloalkenyl, C₂-C₆-haloalkynyl, C₃-C₆-halocycloalkyl, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-cycloalkylamino, C₃-C₆-trialkylsilyl or represents phenyl, benzyl or phenoxy, each of which is optionally mono- or polysubstituted, where the substituents independently of one another may be selected from the group consisting of C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfinyl, C₁-C₄-alkylsulfonyl, C₁-C₄-alkylamino, C₂-C₈-dialkylamino, C₃-C₆-cycloalkylamino, C₃-C₆-(alkyl)cycloalkylamino, C₂-C₄-alkylcarbonyl, C₂-C₆-alkoxycarbonyl, C₂-C₆-alkylaminocarbonyl, C₃-C₈-dialkylaminocarbonyl and C₃-C₆-trialkylsilyl,
R⁵ and R⁸ in each case independently of one another represent hydrogen, halogen or represent in each case optionally substituted C₁-C₄-alkyl, C₁-C₄-haloalkyl, R¹², G, J, —OJ, —OG, —S(O)ₚ-J, —S(O)ₚG, —S(O)ₚ-phenyl, where the substituents independently of one another may be selected from one to three radicals W or from the group consisting of R¹², C₁-C₁₀-alkyl, C₂-C₆-alkenyl, C₂-C₆-alkynyl, C₁-C₄-alkoxy and C₁-C₄-alkylthio, where each substituent may be substituted by one or more substituents independently of one another selected from the group consisting of G, J,
R⁶, halogen, cyano, nitro, amino, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-trialkylsilyl, phenyl and phenoxy, where each phenyl or phenoxy ring may optionally be substituted and where the substituents independently of one another may be selected from one to three radicals W or one or more radicals R¹²,
G in each case independently of one another represents a 5- or 6-membered non-aromatic carbocyclic or heterocyclic ring which may optionally contain one or two ring members from the group consisting of C(═O), SO and S(═O)₂ and which may optionally be substituted by one to four substituents independently of one another selected from the group consisting of C₁-C₂-alkyl, halogen, cyano, nitro and C₁-C₂-alkoxy, or independently of one another represents C₂-C₆-alkenyl, C₂-C₆-alkynyl, C₃-C₇-cycloalkyl, (cyano)-C₃-C₇-cycloalkyl, (C₁-C₄-alkyl)-C₃-C₆-cycloalkyl, (C₃-C₆-cycloalkyl)-C₁-C₄-alkyl, where each cycloalkyl, (alkyl)cycloalkyl and (cycloalkyl)alkyl may optionally be substituted by one or more halogen atoms,
J in each case independently of one another represents an optionally substituted 5- or 6-membered heteroaromatic ring, where the substituents independently of one another may be selected from one to three radicals W or one or more radicals R¹²,
R⁶ independently of one another represents —C(=E¹)R¹⁹, -L(=E¹)R¹⁹, —C(=E¹)LR¹⁹, -LC(=E¹)LR¹⁹, —OP(=Q)(OR¹⁹)₂, —SO₂LR¹⁸ or -LSO₂LR¹⁹, where each
E¹ independently of one another represents O, S, N—R¹⁵, N—OR¹⁵, N—N(R¹⁵)₂, N—S═O, N—CN or N—NO₂,
R⁷ represents hydrogen, C₁-C₄-alkyl, C₁-C₄-haloalkyl, halogen, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl,
R⁹ represents C₁-C₄-haloalkyl, C₁-C₄-haloalkoxy, C₁-C₄-haloalkylsulfinyl or halogen,
R¹⁰ represents hydrogen, C₁-C₄-alkyl, C₁-C₄-haloalkyl, halogen, cyano or C₁-C₄-haloalkoxy,
R¹¹ in each case independently of one another represents in each case optionally mono- to trisubstituted C₁-C₆-alkylthio, C₁-C₆-alkylsulfenyl, C₁-C₆-haloalkylthio, C₁-C₆-haloalkylsulfenyl, phenylthio or phenylsulfenyl, where the substituents independently of one another may be selected from the list W, —S(O)ₙN(R¹⁶)₂, —C(═O)R¹³, -L(C═O)R¹⁴, —S(C═O)LR¹⁴, —C(═O)LR¹³, —S(O)ₙNR¹³C(═O)R¹³, —S(O)ₙNR¹³C(═O)LR¹⁴ or —S(O)ₙNR¹³S(O)₂LR¹⁴,
L in each case independently of one another represents O, NR¹⁸ or S,
R¹² in each case independently of one another represents —B(OR¹⁷)₂, amino, SH, thiocyanato, C₃-C₈-trialkylsilyloxy, C₁-C₄-alkyl disulfides, —SF₅, —C(=E)R¹⁹, -LC(=E¹)R¹⁹, —C(=E¹)LR¹⁹, -LC(=E¹)LR¹⁹, —OP(=Q)(OR⁹)₂, —SO₂LR¹⁹ or -LSO₂LR¹⁹,
Q represents O or S,
R¹³ in each case independently of one another represents hydrogen or represents in each case optionally mono- or polysubstituted C₁-C₆-alkyl, C₂-C₆-alkenyl, C₂-C₆-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino or (C₁-C₄-alkyl)-C₃-C₆-cycloalkylamino,
R¹⁴ in each case independently of one another represents in each case optionally mono- or polysubstituted C₂-C₂₀-alkenyl, C₂-C₂₀-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino and (C₁-C₄-alkyl)-C₃-C₆-cycloalkylamino or represent optionally substituted phenyl, where the substituents independently of one another may be selected from one to three radicals W or one or more radicals R¹²,
R¹⁵ in each case independently of one another represents hydrogen or represents in each case optionally mono- or polysubstituted C₁-C₆-haloalkyl or C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₂-C₆-alkoxycarbonyl, C₂-C₆-alkylcarbonyl, C₃-C₆-trialkylsilyl and optionally substituted phenyl, where the substituents independently of one another may be selected from one to three radicals W or one or more radicals R¹², or N(R¹⁵)₂ represents a cycle which forms the ring M,
R¹⁶ represents C₁-C₁₂-alkyl or C₁-C₁₂-haloalkyl, or N(R¹⁶)₂ represents a cycle which forms the ring M,
R¹⁷ in each case independently of one another represents hydrogen or C₁-C₄-alkyl, or B(OR¹⁷)₂ represents a ring in which the two oxygen atoms are attached via a chain having two to three carbon atoms which are optionally substituted by one or two substituents independently of one another selected from the group consisting of methyl and C₂-C₆-alkoxycarbonyl,
R¹⁸ in each case independently of one another represents hydrogen, C₁-C₆-alkyl or C₁-C₆-haloalkyl, or N(R¹³)(R⁸) represents a cycle which forms the ring M,
R¹⁹ in each case independently of one another represents hydrogen or represents in each case mono- or polysubstituted C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, CO₂H, C₂-C₆-alkoxycarbonyl, C₂-C₆-alkylcarbonyl, C₃-C₆-trialkylsilyl and optionally substituted phenyl, where the substituents independently of one another may be selected from one to three radicals W, C₁-C₆-haloalkyl, C₃-C₆-cycloalkyl or phenyl or pyridyl, each of which is optionally mono- to trisubstituted by W,
M in each case represents an optionally mono- to tetrasubstituted ring which, in addition to the nitrogen atom attached to the substituent pair R¹³ and R¹⁸, (R¹⁵)₂ or (R¹⁶)₂, contains two to six carbon atoms and optionally additionally a further nitrogen, sulfur or oxygen atom, where the substituents independently of one another may be selected from the group consisting of C₁-C₂-alkyl, halogen, cyano, nitro and C₁-C₂-alkoxy,
W in each case independently of one another represents C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfonyl, C₁-C₄-alkylamino, C₂-C₈-dialkylamino, C₃-C₆-cycloalkylamino, (C₁-C₄-alkyl)-C₃-C₆-cycloalkylamino, C₂-C₄-alkylcarbonyl, C₂-C₆-alkoxycarbonyl, CO₂H, C₂-C₆-alkylaminocarbonyl, C₃-C₈-dialkylaminocarbonyl or C₃-C₆-trialkylsilyl,
n in each case independently of one another represents 0 or 1,
p in each case independently of one another represents 0, 1 or 2,
where, if (a) R⁵ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio or halogen and (b) R⁸ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio, halogen, C₂-C₄-alkylcarbonyl, C₂-C₆-alkoxycarbonyl, C₂-C₆-alkylaminocarbonyl or C₃-C₈ dialkylaminocarbonyl, (c) at least one substituent selected from the group consisting of R⁶, R¹¹ and R¹² if present and (d) if R¹² is not present, at least one of the radicals R⁶ and R¹¹ is different from C₂-C₆-alkylcarbonyl, C₂-C₆-alkoxycarbonyl, C₂-C₆-alkylaminocarbonyl and C₃-C₈-dialkylaminocarbonyl, and where the compound of the general formula (I) may also be an N-oxide or salt;
(ii) fluensulfone; (iii) a strobilurin fungicide; and optionally (iv) a neonicotinoid insecticide.

7. The pesticidal mixture of claim 6, wherein the anthranilamide compound of formula (I), fluensulfone, the strobilurin fungicide and optionally the neonicotinoid insecticide are applied jointly or in a succession.

8. A pesticidal mixture comprising: (i) an anthranilamide compound of formula (I) 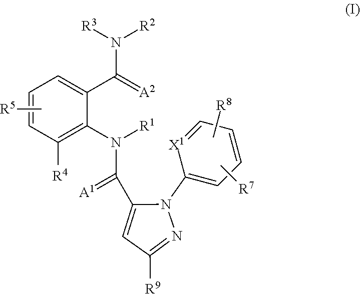
in which
A¹ and A² independently of one another represent oxygen or sulfur,
X¹ represents N or CR¹⁰,
R¹ represents hydrogen or represents C₁-C₆-alkyl, C₂-C₆-alkenyl, C₂-C₆-alkynyl or C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-alkylthio, C₁-C₄-alkylsulfinyl, C₁-C₄-alkylsulfonyl, C₂-C₄-alkoxycarbonyl, C₁-C₄-alkylamino, C₂-C₈-dialkylamino, C₃-C₆-cycloalkylamino, (C₁-C₄-alkyl)-C₃-C₆-cycloalkylamino and R¹¹,
R² represents hydrogen, C₁-C₆-alkyl, C₂-C₆-alkenyl, C₂-C₆-alkynyl, C₃-C₆-cycloalkyl, C₁-C₄-alkoxy, C₁-C₄-alkylamino, C₂-C₈-dialkylamino, C₃-C₆-cycloalkylamino, C₂-C₆-alkoxycarbonyl or C₂-C₆-alkylcarbonyl,
R³ represents hydrogen, R¹¹ or represents C₁-C₆-alkyl, C₂-C₆-alkenyl, C₂-C₆-alkynyl, C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₂-C₆-alkoxycarbonyl, C₂-C₆-alkylcarbonyl, C₃-C₆-trialkylsilyl, R¹¹, phenyl, phenoxy and a 5- or 6-membered heteroaromatic ring, where each phenyl, phenoxy and 5- or 6-membered heteroaromatic ring may optionally be substituted and where the substituents independently of one another may be selected from one to three radicals W or one or more radicals R¹², or
R² and R³ may be attached to one another and form the ring M,
R⁴ represents hydrogen, C₁-C₆-alkyl, C₂-C₆-alkenyl, C₂-C₆-alkynyl, C₃-C₆-cycloalkyl, C₁-C₆-haloalkyl, C₂-C₆-haloalkenyl, C₂-C₆-haloalkynyl, C₃-C₆-halocycloalkyl, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-cycloalkylamino, C₃-C₆-trialkylsilyl or represents phenyl, benzyl or phenoxy, each of which is optionally mono- or polysubstituted, where the substituents independently of one another may be selected from the group consisting of C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfinyl, C₁-C₄-alkylsulfonyl, C₁-C₄-alkylamino, C₂-C₈-dialkylamino, C₃-C₆-cycloalkylamino, C₃-C₆-(alkyl)cycloalkylamino, C₂-C₄-alkylcarbonyl, C₂-C₆-alkoxycarbonyl, C₂-C₆-alkylaminocarbonyl, C₃-C₈-dialkylaminocarbonyl and C₃-C₆-trialkylsilyl,
R⁵ and R⁸ in each case independently of one another represent hydrogen, halogen or represent in each case optionally substituted C₁-C₄-alkyl, C₁-C₄-haloalkyl, R¹², G, J, —OJ, —OG, —S(O)ₚ-J, —S(O)ₚG, —S(O)ₚ-phenyl, where the substituents independently of one another may be selected from one to three radicals W or from the group consisting of R¹², C₁-C₁₀-alkyl, C₂-C₆-alkenyl, C₂-C₆-alkynyl, C₁-C₄-alkoxy and C₁-C₄-alkylthio, where each substituent may be substituted by one or more substituents independently of one another selected from the group consisting of G, J,
R⁶, halogen, cyano, nitro, amino, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-trialkylsilyl, phenyl and phenoxy, where each phenyl or phenoxy ring may optionally be substituted and where the substituents independently of one another may be selected from one to three radicals W or one or more radicals R¹²,
G in each case independently of one another represents a 5- or 6-membered non-aromatic carbocyclic or heterocyclic ring which may optionally contain one or two ring members from the group consisting of C(═O), SO and S(═O)₂ and which may optionally be substituted by one to four substituents independently of one another selected from the group consisting of C₁-C₂-alkyl, halogen, cyano, nitro and C₁-C₂-alkoxy, or independently of one another represents C₂-C₆-alkenyl, C₂-C₆-alkynyl, C₃-C₇-cycloalkyl, (cyano)-C₃-C₇-cycloalkyl, (C₁-C₄-alkyl)-C₃-C₆-cycloalkyl, (C₃-C₆-cycloalkyl)-C₁-C₄-alkyl, where each cycloalkyl, (alkyl)cycloalkyl and (cycloalkyl)alkyl may optionally be substituted by one or more halogen atoms,
J in each case independently of one another represents an optionally substituted 5- or 6-membered heteroaromatic ring, where the substituents independently of one another may be selected from one to three radicals W or one or more radicals R¹²,
R⁶ independently of one another represents —C(=E¹)R¹⁹, -L(=E¹)R¹⁹, —C(=E¹)LR¹⁹, -LC(=E¹)LR¹⁹, —OP(=Q)(OR¹⁹)₂, —SO₂LR¹⁸ or -LSO₂LR¹⁹, where each
E¹ independently of one another represents O, S, N—R¹⁵, N—OR¹⁵, N—N(R¹⁵)₂, N—S═O, N—CN or N—NO₂,
R⁷ represents hydrogen, C₁-C₄-alkyl, C₁-C₄-haloalkyl, halogen, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl,
R⁹ represents C₁-C₄-haloalkyl, C₁-C₄-haloalkoxy, C₁-C₄-haloalkylsulfinyl or halogen,
R¹⁰ represents hydrogen, C₁-C₄-alkyl, C₁-C₄-haloalkyl, halogen, cyano or C₁-C₄-haloalkoxy,
R¹¹ in each case independently of one another represents in each case optionally mono- to trisubstituted C₁-C₆-alkylthio, C₁-C₆-alkylsulfenyl, C₁-C₆-haloalkylthio, C₁-C₆-haloalkylsulfenyl, phenylthio or phenylsulfenyl, where the substituents independently of one another may be selected from the list W, —S(O)ₙN(R¹⁶)₂, —C(═O)R¹³, -L(C═O)R¹⁴, —S(C═O)LR¹⁴, —C(═O)LR¹³, —S(O)ₙNR¹³C(═O)R¹³, —S(O)ₙNR¹³C(═O)LR¹⁴ or —S(O)ₙNR¹³S(O)₂LR¹⁴,
L in each case independently of one another represents O, NR¹⁸ or S,
R¹² in each case independently of one another represents —B(OR¹⁷)₂, amino, SH, thiocyanato, C₃-C₈-trialkylsilyloxy, C₁-C₄-alkyl disulfides, —SF₅, —C(=E)R¹⁹, -LC(=E¹)R¹⁹, —C(=E¹)LR¹⁹, -LC(=E¹)LR¹⁹, —OP(=Q)(OR⁹)₂, —SO₂LR¹⁹ or -LSO₂LR¹⁹,
Q represents O or S,
R¹³ in each case independently of one another represents hydrogen or represents in each case optionally mono- or polysubstituted C₁-C₆-alkyl, C₂-C₆-alkenyl, C₂-C₆-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino or (C₁-C₄-alkyl)-C₃-C₆-cycloalkylamino,
R¹⁴ in each case independently of one another represents in each case optionally mono- or polysubstituted C₂-C₂₀-alkenyl, C₂-C₂₀-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino and (C₁-C₄-alkyl)-C₃-C₆-cycloalkylamino or represent optionally substituted phenyl, where the substituents independently of one another may be selected from one to three radicals W or one or more radicals R¹²,
R¹⁵ in each case independently of one another represents hydrogen or represents in each case optionally mono- or polysubstituted C₁-C₆-haloalkyl or C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₂-C₆-alkoxycarbonyl, C₂-C₆-alkylcarbonyl, C₃-C₆-trialkylsilyl and optionally substituted phenyl, where the substituents independently of one another may be selected from one to three radicals W or one or more radicals R¹², or
N(R¹⁵)₂ represents a cycle which forms the ring M,
R¹⁶ represents C₁-C₁₂-alkyl or C₁-C₁₂-haloalkyl, or N(R¹⁶)₂ represents a cycle which forms the ring M,
R¹⁷ in each case independently of one another represents hydrogen or C₁-C₄-alkyl, or B(OR¹⁷)₂ represents a ring in which the two oxygen atoms are attached via a chain having two to three carbon atoms which are optionally substituted by one or two substituents independently of one another selected from the group consisting of methyl and C₂-C₆-alkoxycarbonyl,
R¹⁸ in each case independently of one another represents hydrogen, C₁-C₆-alkyl or C₁-C₆-haloalkyl, or N(R¹³)(R⁸) represents a cycle which forms the ring M,
R¹⁹ in each case independently of one another represents hydrogen or represents in each case mono- or polysubstituted C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, CO₂H, C₂-C₆-alkoxycarbonyl, C₂-C₆-alkylcarbonyl, C₃-C₆-trialkylsilyl and optionally substituted phenyl, where the substituents independently of one another may be selected from one to three radicals W, C₁-C₆-haloalkyl, C₃-C₆-cycloalkyl or phenyl or pyridyl, each of which is optionally mono- to trisubstituted by W,
M in each case represents an optionally mono- to tetrasubstituted ring which, in addition to the nitrogen atom attached to the substituent pair R¹³ and R¹⁸, (R¹⁵)₂ or (R¹⁶)₂, contains two to six carbon atoms and optionally additionally a further nitrogen, sulfur or oxygen atom, where the substituents independently of one another may be selected from the group consisting of C₁-C₂-alkyl, halogen, cyano, nitro and C₁-C₂-alkoxy,
W in each case independently of one another represents C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfonyl, C₁-C₄-alkylamino, C₂-C₈-dialkylamino, C₃-C₆-cycloalkylamino, (C₁-C₄-alkyl)-C₃-C₆-cycloalkylamino, C₂-C₄-alkylcarbonyl, C₂-C₆-alkoxycarbonyl, CO₂H, C₂-C₆-alkylaminocarbonyl, C₃-C₈-dialkylaminocarbonyl or C₃-C₆-trialkylsilyl,
n in each case independently of one another represents 0 or 1,
p in each case independently of one another represents 0, 1 or 2,
where, if (a) R⁵ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio or halogen and (b) R⁸ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio, halogen, C₂-C₄-alkylcarbonyl, C₂-C₆-alkoxycarbonyl, C₂-C₆-alkylaminocarbonyl or C₃-C₈ dialkylaminocarbonyl, (c) at least one substituent selected from the group consisting of R⁶, R¹¹ and R¹² if present and (d) if R¹² is not present, at least one of the radicals R⁶ and R¹¹ is different from C₂-C₆-alkylcarbonyl, C₂-C₆-alkoxycarbonyl, C₂-C₆-alkylaminocarbonyl and C₃-C₈-dialkylaminocarbonyl, and where the compound of the general formula (I) may also be an N-oxide or salt;
(ii) fluensulfone; (iii) a neonicotinoid insecticide; and optionally (iv) a strobilurin fungicide.

9. The pesticidal mixture of claim 8, wherein the anthranilamide compound of formula (I), fluensulfone, the neonicotinoid insecticide and optionally the strobilurin fungicide are applied jointly or in a succession.

10. A pesticidal mixture comprising: (i) an anthranilamide compound of formula (I) 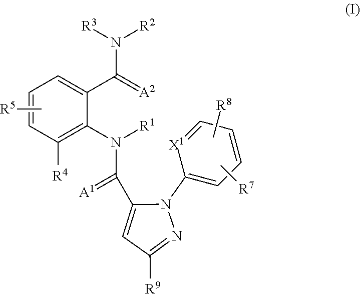
in which
A¹ and A² independently of one another represent oxygen or sulfur,
X¹ represents N or CR¹⁰,
R¹ represents hydrogen or represents C₁-C₆-alkyl, C₂-C₆-alkenyl, C₂-C₆-alkynyl or C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-alkylthio, C₁-C₄-alkylsulfinyl, C₁-C₄-alkylsulfonyl, C₂-C₄-alkoxycarbonyl, C₁-C₄-alkylamino, C₂-C₈-dialkylamino, C₃-C₆-cycloalkylamino, (C₁-C₄-alkyl)-C₃-C₆-cycloalkylamino and R¹¹,
R² represents hydrogen, C₁-C₆-alkyl, C₂-C₆-alkenyl, C₂-C₆-alkynyl, C₃-C₆-cycloalkyl, C₁-C₄-alkoxy, C₁-C₄-alkylamino, C₂-C₈-dialkylamino, C₃-C₆-cycloalkylamino, C₂-C₆-alkoxycarbonyl or C₂-C₆-alkylcarbonyl,
R³ represents hydrogen, R¹¹ or represents C₁-C₆-alkyl, C₂-C₆-alkenyl, C₂-C₆-alkynyl, C₃-C₆-cycloalkyl, each of which is optionally mono- or polysubstituted, where the substituents independently of one another may be selected from the group consisting of R⁶, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₂-C₆-alkoxycarbonyl, C₂-C₆-alkylcarbonyl, C₃-C₆-trialkylsilyl, R¹¹, phenyl, phenoxy and a 5- or 6-membered heteroaromatic ring, where each phenyl, phenoxy and 5- or 6-membered heteroaromatic ring may optionally be substituted and where the substituents independently of one another may be selected from one to three radicals W or one or more radicals R¹², or
R² and R³ may be attached to one another and form the ring M,
R⁴ represents hydrogen, C₁-C₆-alkyl, C₂-C₆-alkenyl, C₂-C₆-alkynyl, C₃-C₆-cycloalkyl, C₁-C₆-haloalkyl, C₂-C₆-haloalkenyl, C₂-C₆-haloalkynyl, C₃-C₆-halocycloalkyl, halogen, cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-cycloalkylamino, C₃-C₆-trialkylsilyl or represents phenyl, benzyl or phenoxy, each of which is optionally mono- or polysubstituted, where the substituents independently of one another may be selected from the group consisting of C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfinyl, C₁-C₄-alkylsulfonyl, C₁-C₄-alkylamino, C₂-C₈-dialkylamino, C₃-C₆-cycloalkylamino, C₃-C₆-(alkyl)cycloalkylamino, C₂-C₄-alkylcarbonyl, C₂-C₆-alkoxycarbonyl, C₂-C₆-alkylaminocarbonyl, C₃-C₈-dialkylaminocarbonyl and C₃-C₆-trialkylsilyl,
R⁵ and R⁸ in each case independently of one another represent hydrogen, halogen or represent in each case optionally substituted C₁-C₄-alkyl, C₁-C₄-haloalkyl, R¹², G, J, —OJ, —OG, —S(O)ₚ-J, —S(O)ₚG, —S(O)ₚ-phenyl, where the substituents independently of one another may be selected from one to three radicals W or from the group consisting of R¹², C₁-C₁₀-alkyl, C₂-C₆-alkenyl, C₂-C₆-alkynyl, C₁-C₄-alkoxy and C₁-C₄-alkylthio, where each substituent may be substituted by one or more substituents independently of one another selected from the group consisting of G, J,
R⁶, halogen, cyano, nitro, amino, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₃-C₆-trialkylsilyl, phenyl and phenoxy, where each phenyl or phenoxy ring may optionally be substituted and where the substituents independently of one another may be selected from one to three radicals W or one or more radicals R¹²,
G in each case independently of one another represents a 5- or 6-membered non-aromatic carbocyclic or heterocyclic ring which may optionally contain one or two ring members from the group consisting of C(═O), SO and S(═O)₂ and which may optionally be substituted by one to four substituents independently of one another selected from the group consisting of C₁-C₂-alkyl, halogen, cyano, nitro and C₁-C₂-alkoxy, or independently of one another represents C₂-C₆-alkenyl, C₂-C₆-alkynyl, C₃-C₇-cycloalkyl, (cyano)-C₃-C₇-cycloalkyl, (C₁-C₄-alkyl)-C₃-C₆-cycloalkyl, (C₃-C₆-cycloalkyl)-C₁-C₄-alkyl, where each cycloalkyl, (alkyl)cycloalkyl and (cycloalkyl)alkyl may optionally be substituted by one or more halogen atoms,
J in each case independently of one another represents an optionally substituted 5- or 6-membered heteroaromatic ring, where the substituents independently of one another may be selected from one to three radicals W or one or more radicals R¹²,
R⁶ independently of one another represents —C(=E¹)R¹⁹, -L(=E¹)R¹⁹, —C(=E¹)LR¹⁹, -LC(=E¹)LR¹⁹, —OP(=Q)(OR¹⁹)₂, —SO₂LR¹⁸ or -LSO₂LR¹⁹, where each
E¹ independently of one another represents O, S, N—R¹⁵, N—OR¹⁵, N—N(R¹⁵)₂, N S═O, N—CN or N—NO₂,
R⁷ represents hydrogen, C₁-C₄-alkyl, C₁-C₄-haloalkyl, halogen, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl,
R⁹ represents C₁-C₄-haloalkyl, C₁-C₄-haloalkoxy, C₁-C₄-haloalkylsulfinyl or halogen,
R¹⁰ represents hydrogen, C₁-C₄-alkyl, C₁-C₄-haloalkyl, halogen, cyano or C₁-C₄-haloalkoxy,
R¹¹ in each case independently of one another represents in each case optionally mono- to trisubstituted C₁-C₆-alkylthio, C₁-C₆-alkylsulfenyl, C₁-C₆-haloalkylthio, C₁-C₆-haloalkylsulfenyl, phenylthio or phenylsulfenyl, where the substituents independently of one another may be selected from the list W, —S(O)ₙN(R¹⁶)₂, —C(═O)R¹³, -L(C═O)R¹⁴, —S(C═O)LR¹⁴, —C(═O)LR¹³, —S(O)ₙNR¹³C(═O)R¹³, S(O)ₙNR¹³C(═O)LR¹⁴ or —S(O)ₙNR¹³S(O)₂LR¹⁴,
L in each case independently of one another represents O, NR¹⁸ or S,
R¹² in each case independently of one another represents —B(OR¹⁷)₂, amino, SH, thiocyanato, C₃-C₈-trialkylsilyloxy, C₁-C₄-alkyl disulfides, —SF₅, —C(=E)R¹⁹, -LC(=E¹)R¹⁹, —C(=E¹)LR¹⁹, -LC(=E¹)LR¹⁹, —OP(=Q)(OR⁹)₂, —SO₂LR¹⁹ or -LSO₂LR¹⁹,
Q represents O or S,
R¹³ in each case independently of one another represents hydrogen or represents in each case optionally mono- or polysubstituted C₁-C₆-alkyl, C₂-C₆-alkenyl, C₂-C₆-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino or (C₁-C₄-alkyl)-C₃-C₆-cycloalkylamino,
R¹⁴ in each case independently of one another represents in each case optionally mono- or polysubstituted C₂-C₂₀-alkenyl, C₂-C₂₀-alkynyl or C₃-C₆-cycloalkyl, where the substituents independently of one another may be selected from the group consisting of R⁶, halogen, cyano, nitro, hydroxyl, C₁-C₄-alkoxy, C₁-C₄-alkylsulfinyl, C₁-C₄-alkylsulfonyl, C₁-C₄-alkylamino, C₂-C₈-dialkylamino, C₃-C₆-cycloalkylamino and (C₁-C₄-alkyl)-C₃-C₆-cycloalkylamino or represent optionally substituted phenyl, where the substituents independently of one another may be selected from one to three radicals W or one or more radicals R¹²,
R¹⁵ in each case independently of one another represents hydrogen or represents in each case optionally mono- or polysubstituted C₁-C₆-haloalkyl or C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, C₂-C₆-alkoxycarbonyl, C₂-C₆-alkylcarbonyl, C₃-C₆-trialkylsilyl and optionally substituted phenyl, where the substituents independently of one another may be selected from one to three radicals W or one or more radicals R¹², or N(R¹⁵)₂ represents a cycle which forms the ring M,
R¹⁶ represents C₁-C₁₂-alkyl or C₁-C₁₂-haloalkyl, or N(R¹⁶)₂ represents a cycle which forms the ring M,
R¹⁷ in each case independently of one another represents hydrogen or C₁-C₄-alkyl, or B(OR¹⁷)₂ represents a ring in which the two oxygen atoms are attached via a chain having two to three carbon atoms which are optionally substituted by one or two substituents independently of one another selected from the group consisting of methyl and C₂-C₆-alkoxycarbonyl,
R¹⁸ in each case independently of one another represents hydrogen, C₁-C₆-alkyl or C₁-C₆-haloalkyl, or N(R¹³)(R⁸) represents a cycle which forms the ring M,
R¹⁹ in each case independently of one another represents hydrogen or represents in each case mono- or polysubstituted C₁-C₆-alkyl, where the substituents independently of one another may be selected from the group consisting of cyano, nitro, hydroxyl, C₁-C₄-alkoxy, C₁-C₄-haloalkoxy, C₁-C₄-alkylthio, C₁-C₄-alkylsulfinyl, C₁-C₄-alkylsulfonyl, C₁-C₄-haloalkylthio, C₁-C₄-haloalkylsulfinyl, C₁-C₄-haloalkylsulfonyl, C₁-C₄-alkylamino, C₂-C₈-dialkylamino, CO₂H, C₂-C₆-alkoxycarbonyl, C₂-C₆-alkylcarbonyl, C₃-C₆-trialkylsilyl and optionally substituted phenyl, where the substituents independently of one another may be selected from one to three radicals W, C₁-C₆-haloalkyl, C₃-C₆-cycloalkyl or phenyl or pyridyl, each of which is optionally mono- to trisubstituted by W,
M in each case represents an optionally mono- to tetrasubstituted ring which, in addition to the nitrogen atom attached to the substituent pair R¹³ and R¹⁸, (R¹⁵)₂ or (R¹⁶)₂, contains two to six carbon atoms and optionally additionally a further nitrogen, sulfur or oxygen atom, where the substituents independently of one another may be selected from the group consisting of C₁-C₂-alkyl, halogen, cyano, nitro and C₁-C₂-alkoxy,
W in each case independently of one another represents C₁-C₄-alkyl, C₂-C₄-alkenyl, C₂-C₄-alkynyl, C₃-C₆-cycloalkyl, C₁-C₄-haloalkyl, C₂-C₄-haloalkenyl, C₂-C₄-haloalkynyl, C₃-C₆-halocycloalkyl, halogen, cyano, nitro, C₁-C₄-alkoxy, C₁-C₄-haloalkoxy, C₁-C₄-alkylthio, C₁-C₄-alkylsulfonyl, C₁-C₄-alkylamino, C₂-C₈-dialkylamino, C₃-C₆-cycloalkylamino, (C₁-C₄-alkyl)-C₃-C₆-cycloalkylamino, C₂-C₄-alkylcarbonyl, C₂-C₆-alkoxycarbonyl, CO₂H, C₂-C₆-alkylaminocarbonyl, C₃-C₈-dialkylaminocarbonyl or C₃-C₆-trialkylsilyl,
n in each case independently of one another represents 0 or 1,
p in each case independently of one another represents 0, 1 or 2,
where, if (a) R⁵ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio or halogen and (b) R⁸ represents hydrogen, C₁-C₆-alkyl, C₁-C₆-haloalkyl, C₂-C₆-haloalkenyl, C₂-C₆-haloalkynyl, C₁-C₄-haloalkoxy, C₁-C₄-haloalkylthio, halogen, C₂-C₄-alkylcarbonyl, C₂-C₆-alkoxycarbonyl, C₂-C₆-alkylaminocarbonyl or C₃-C₈ dialkylaminocarbonyl, (c) at least one substituent selected from the group consisting of R⁶, R¹¹ and R¹² if present and (d) if R¹² is not present, at least one of the radicals R⁶ and R¹¹ is different from C₂-C₆-alkylcarbonyl, C₂-C₆-alkoxycarbonyl, C₂-C₆-alkylaminocarbonyl and C₃-C₈-dialkylaminocarbonyl, and where the compound of the general formula (I) may also be an N-oxide or salt;
(ii) fluensulfone; (iii) a strobilurin fungicide; and (iv) a neonicotinoid insecticide.

11. The pesticidal mixture of claim 1, wherein the weight ratio of the anthranilamide compound of formula (I), fluensulfone, the strobilurin fungicide and the neonicotinoid insecticide is from 1-100:1-100:1-100:1-100.

12. The pesticidal mixture of claim 11, wherein the weight ratio of the anthranilamide compound of formula (I), fluensulfone, the strobilurin fungicide and the neonicotinoid insecticide is from 1-10:1-20:1-10:1-15.

13. The pesticidal mixture of claim 1, wherein the anthranilamide compound is selected from the group comprising, chlorantraniliprole, cyantraniliprole, tetraniliprole, tetrachlorantraniliprole, bromantraniliprole, and cyclaniliprole.

14. The pesticidal mixture of claim 13, wherein the anthranilamide compound is chlorantraniliprole.

15. The pesticidal mixture of claim 13, wherein the anthranilamide compound is cyantraniliprole.

16. The pesticidal mixture of claim 13, wherein the anthranilamide compound is cyclaniliprole.

17. The pesticidal mixture of claim 13, wherein the anthranilamide compound is tetraniliprole.

18. The pesticidal mixture of claim 1, wherein said strobilurin fungicide is selected from the group consisting of azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin and fluoxastrobin.

19. The pesticidal mixture of claim 18, wherein the strobilurin fungicide is azoxystrobin.

20. The pesticidal mixture of claim 1, wherein said neonicotinoid insecticide is selected from the group consisting of acetamiprid, clothianidin, dinotefuran, imidacloprid, nitenpyram, thiacloprid and thiamethoxam.

21. The pesticidal mixture of claim 20, wherein the neonicotinoid insecticide is thiamethoxam.

22. The pesticidal mixture of claim 1, wherein the mixture comprises chlorantraniliprole, fluensulfone, azoxystrobin and thiamethoxam.

23. The pesticidal mixture of claim 1, comprising about (i) 55 g/l of chlorantraniliprole, and (ii) 240 g/l of fluensulfone.

24. The pesticidal mixture of claim 1, comprising about (i) 35 g/l of chlorantraniliprole, (ii) 160 g/l of fluensulfone, (iii) 60 g/l of thiamethoxam, and (iv) 20 g/l of azoxystrobin.

25. The pesticidal mixture of claim 1, wherein the weight ratio of the anthranilamide compound of formula (I), fluensulfone, the strobilurin fungicide and the neonicotinoid insecticide is from about 1.75:8:1:3.

26. The pesticidal mixture of claim 1, wherein the mixture exhibits synergistic effect.

27. The pesticidal mixture of claim 1 wherein the anthranilamide compound of formula (I), fluensulfone, the strobilurin fungicide and the neonicotinoid insecticide are applied jointly or in a succession.

28. A pesticidal composition comprising: (i) the mixture of claim 1; and (ii) an agriculturally acceptable carrier.

29. The pesticidal composition of claim 28, further comprising at least one surfactant, solid diluent, liquid diluent, or a combination thereof

30. A method for enhancing plant development comprising applying to the plant, a locus of the plant and/or propagation material of the plant an effective amount of the mixture of claim 1 so as to thereby enhance plant development.

31. The method of claim 30, wherein:
a) the method enhances root development,
b) the method enhances the root system of the plant,
c) the method enhances plant quality,
d) the method enhances plant vigor,
e) the method enhances plant yield,
f) the method prevents root damage, and/or
g) the method improves rooting.

32. A method for controlling nematodes comprising applying to the plant, a locus of the plant and/or propagation material of the plant an effective amount of the mixture of claim 1 so as to thereby control nematodes.

33. A method for regulating plant growth comprising applying to the plant, a locus of the plant and/or propagation material of the plant an effective amount of the mixture of claim 1 so as to thereby regulate plant growth.

34. A method for controlling insects comprising contacting the insect or their food supply, habitat, breeding grounds or their locus with an effective amount of the mixture of claim 1 so as to thereby control insects.

35. A method for protecting plants from attack or infestation by insects comprising contacting the plant, or the soil or water in which the plant is growing, with an effective amount of the mixture of claim 1 so as to thereby protecting plants from attack or infestation by insects.

36. A method for control of fungal disease comprising applying an effective amount of the mixture of claim 1 to one or more plants, the locus thereof or propagation material thereof so as to thereby control fungal disease.

37. The method of claim 30, wherein the plant is sugarcane.

38. The method of claim 30, wherein an effective amount of the composition is applied at a rate of 1-100 L/ha.

39. The method of claim 30, wherein:
h) chlorantraniliprole is applied at an amount from about 1 g/ha to about 1000 g/ha
i) fluensulfone is applied at an amount from about 1 g/ha to about 1000 g/ha,
j) the strobilurin fungicide is applied at an amount from about 1 g/ha to about 1000 g/ha, and/or
k) the neonicotinoid insecticide is applied at an amount from about 1 g/ha to about 1000 g/ha.
